(19) United States
(12) Patent Application Publication
(10) Pub. No.: US 2011/0167097 A1
(43) Pub. Date: Jul. 7, 2011

(54) INFORMATION MANAGEMENT SYSTEM, INFORMATION MANAGEMENT APPARATUS, AND INFORMATION MANAGEMENT METHOD

(76) Inventor: Atsushi ONODA, Yokohama (JP)

(21) Appl. No.: 12/981,831

(22) Filed: Dec. 30, 2010

(30) Foreign Application Priority Data
Jan. 6, 2010 (JP) 2010-001491

(51) Int. Cl. G06F 17/30; G06F 15/16; G06F 17/21

(52) U.S. Cl. 707/822; 709/201; 715/200; 707/E17.009

(57) ABSTRACT

An information management system, information management apparatus, and information management method. The system comprising a relay unit that is configured to receive a request, including an identifier and a parameter, to execute a scanning process on an image forming apparatus selected by a user. The relay unit is further configured to send the request to the image forming apparatus, to receive image data from the image forming apparatus, and to return the image data to an application in an apparatus and corresponding to the identifier. The information management apparatus includes a history recording unit configured to receive and record history information including the identifier, the parameter, and the image data, and a history providing unit configured to send a list of the history information in the history recording unit in response to receiving a request to display the history information from a web browser.

### CROSS-REFERENCE TO RELATED APPLICATIONS

The present application claims the benefit of priority under 35 U.S.C. §119 to Japanese Priority Patent Application No. 2010-001491, filed on Jan. 6, 2010, the entire contents of which are hereby incorporated herein by reference.

### BACKGROUND OF THE INVENTION

1. Field of the Invention

The present invention relates to an information management system, an information management apparatus, and an information management method.

2. Description of the Related Art

In recent years, a mechanism has been proposed in which an image forming apparatus operates in collaboration with an application executed in another computer connected to the image forming apparatus via a network (see, for example, Japanese Laid-Open Patent Application No. 2009-070386). The application is called a “widget” and is easily installed and used by a user.

Meanwhile, performing processing procedures between the widget and the image forming apparatus, print, scan, and image data are transferred between the widget and the image forming apparatus. If the image data can be managed properly, conveniences of a whole system including the widget can be improved dramatically.

### SUMMARY OF THE INVENTION

The present invention provides an information management system, an information management apparatus, and an information management method.

A preferred embodiment of the present invention provides an information management apparatus, an information management method, and an information management system for which a simple mechanism is implemented for managing image data that is provided by collaboration between an image forming apparatus and an external application.

According to an aspect of the present invention, there is provided an information management system including a relay unit and an information management apparatus. The relay unit is configured to receive a request, including an identifier and a parameter, to execute a scanning process on an image forming apparatus selected by a user, to send the request to the image forming apparatus, to receive image data from the image forming apparatus, and to return the image data to an application in an apparatus and corresponding to the identifier. The information management apparatus includes a history recording unit configured to receive history information including the identifier, the parameter, and the image data, and to record the history information. The information management apparatus further includes a history providing unit configured to send a list of the history information in the history recording unit in response to receiving a request to display the history information.

According to an aspect of the present invention, there is provided an information management apparatus that is configured to connect to an image forming apparatus and a relay unit via a network. The information management apparatus includes a history recording unit and a history providing unit. The history recording unit is configured to receive history information including an identifier, a parameter, and image data sent by the relay unit, and to record the history information. The history providing unit is configured to send a list of the history information in the history recording unit in response to receiving a request to display the history information.

According to an aspect of the present invention, there is provided an information management method performed by a relay unit and an application in an apparatus. The method includes receiving, by the relay unit, a request, including an identifier and a parameter, to execute a scanning process on an image forming apparatus selected by a user. The method further includes, performing by the relay unit, sending of the request to the image forming apparatus, receiving image data from the image forming apparatus, and returning the image data to an application corresponding to the identifier. Further, the information management apparatus receives history information including the identifier, the parameter, and the image data, records the history information, and sends a list of the history information in the information management apparatus in response to receiving a request to display the history information.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of an information management system according to an embodiment of the present invention;

FIG. 2 illustrates a hardware configuration of a widget management server according to an embodiment of the present invention;

FIG. 3 illustrates a hardware configuration of an image forming apparatus according to an embodiment of the present invention;

FIG. 4 illustrates a software configuration of the information management system according to an embodiment of the present invention;

FIG. 5 is a sequence diagram of processing procedures that are performed when widget information is sent;

FIG. 6 illustrates an example of widget information corresponding to a scan OCR distribution widget;

FIG. 7 illustrates an example of an active user list;

FIG. 8 is a sequence diagram of processing procedures that are performed when executing a process flow of a scan OCR distribution widget;

FIG. 9 illustrates an example of a displayed user selection screen page;

FIG. 10 illustrates an example of a list of widget information;

FIG. 11 illustrates an example of a displayed widget selection screen page;

FIG. 12 illustrates an example of an individual history store unit;

FIG. 13 is a sequence diagram of processing procedures that are performed when downloading a widget;

FIG. 14 illustrates an exemplary configuration of a widget list store unit;

FIG. 15 illustrates an example of a displayed widget list screen page;

FIG. 16 illustrates an example of a displayed widget detail screen page;

FIG. 17 illustrates a configuration of an individual widget list store unit;

FIG. 18 is a sequence diagram of processing procedures that are performed when making a derivation widget;

FIG. 19 illustrates an example of a displayed individual widget list screen page;

FIG. 20 illustrates an example of a displayed source widget list screen page;

FIG. 21 illustrates an example of a displayed source widget list screen page;

FIG. 22 illustrates an example of a displayed confirmation screen page;

FIG. 23 is a sequence diagram of processing procedures that are performed when reusing an execution history;

FIG. 24 illustrates an example of a displayed history list screen page;

FIG. 25 illustrates an example of a displayed history detail screen page; and

FIG. 26 is a flowchart illustrating processing procedures that are performed when resending terminal data.

### DETAILED DESCRIPTION OF THE PREFERRED EMBODIMENTS

A description is now given, with reference to the accompanying drawings, of embodiments of the present invention.

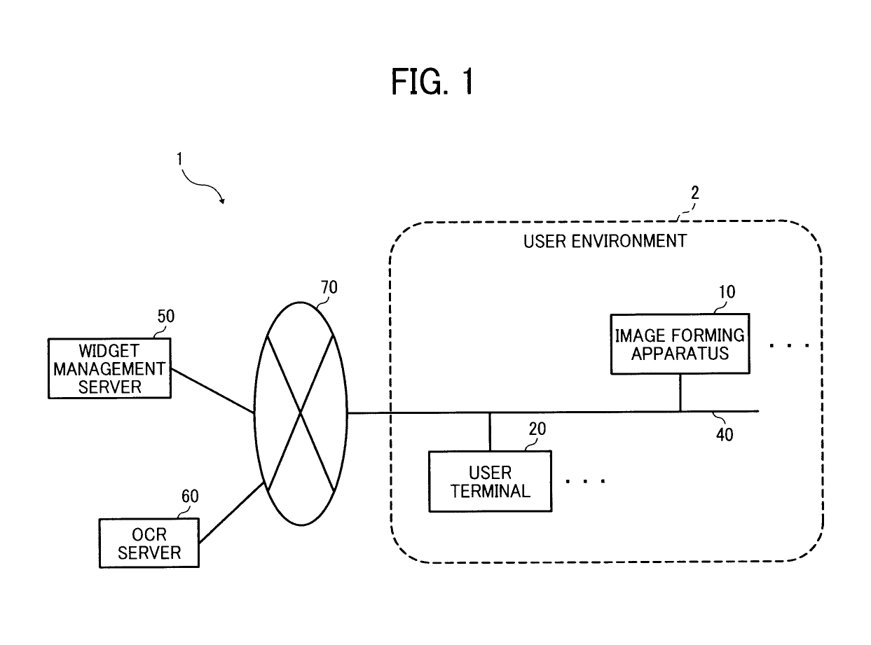

FIG. 1 illustrates a configuration of an information management system 1 according to an embodiment of the present invention. As illustrated in FIG. 1, the information management system 1 includes a user environment 2, a widget management server 50, and an OCR server 60 which are connected to each other via a global network 70, such as the Internet.

In one embodiment, the widget management server 50 is installed at the manufacturer or the distributor of an image forming apparatus 10. The widget management server 50 is a computer that is configured to provide a website via the global network 70 to manage programs called “widgets,” as will hereinafter be described in detail (hereinafter, “widget management site”).

The OCR server 60 is a computer that is configured to provide a web service for performing an OCR (Optical Character Recognition) function regardless of whether or not compensation is received.

In one embodiment, the user environment 2 shown in FIG. 1 is a network of devices connected to each other in a user's office. The user environment 2 includes at least one image forming apparatus 10 and at least one user terminal 20, which are connected to each other by a network 40 (wired or wireless) such as a LAN (Local Area Network).

In one embodiment, the image forming apparatus 10 is a multifunction peripheral that implements plural functions such as printing, scanning, copying, and transmitting/receiving information by fax communications, in a single casing. However, in another embodiment, the image forming apparatus 10 is a device without a printing function such as a scanner.

The user terminal 20, in one embodiment, is a personal terminal used by a user, in which software programs can be installed and executed. The user terminal 20 is not limited to any particular type of device as long as it has a communication function. Examples of the user terminal 20 include information processing devices such as a desktop PC (Personal Computer), a notebook PC, a PDA (Personal Digital Assistant), and a mobile phone.

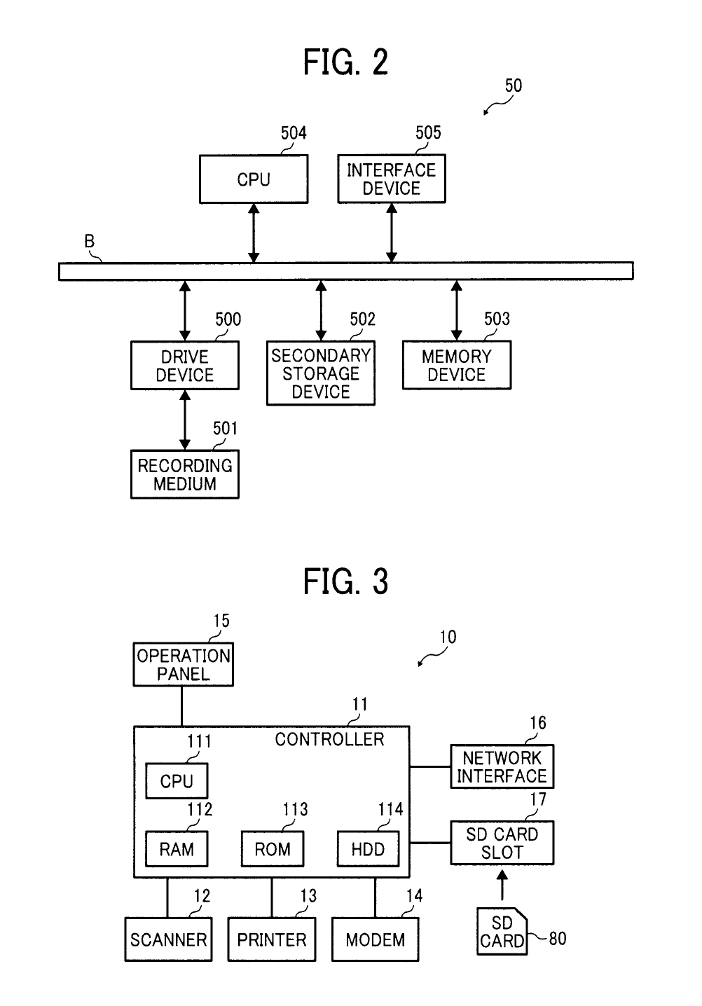

FIG. 2 illustrates a hardware configuration of the widget management server 50 according to an embodiment of the present invention. The widget management server 50, illustrated in FIG. 2, includes a drive device 500, a secondary storage device 502, a memory device 503, a CPU (central processing unit) 504, and an interface device 505, which are interconnected via a bus B.

A program that implements the functions of the widget management server 50 is provided in a recording medium 501 such as a CD-ROM. When the recording medium 501 storing the program is set in the drive device 500, the program is installed from the recording medium 501 into the secondary storage device 502 via the drive device 500. However, the program need not be installed from the recording medium 501. In another embodiment, the program may be downloaded from another computer via a network and installed. The secondary storage device 502 stores the installed program, together with necessary files and data.

The memory device 503 reads the program from the secondary storage device 502 and stores the program, when an instruction to activate the program has been given. The CPU 504 implements the functions pertaining to the widget management server 50 in accordance with the program stored in the memory device 503. The interface device 505 is used as an interface for connecting the widget management server 50 to a network.

In one embodiment, the OCR server 60 and the user terminal 20 are also constructed with hardware configurations corresponding to the hardware configuration shown in FIG. 2. However, the user terminal 20 may further include a display device such as an LCD (Liquid Crystal Display) or an input device such as a keyboard and/or a mouse.

FIG. 3 illustrates a hardware configuration of the image forming apparatus 10 according to an embodiment of the present invention. As shown in FIG. 3, the image forming apparatus 10 includes hardware elements such as a controller 11, a scanner 12, a printer 13, a modem 14, an operation panel 15, a network interface 16, and an SD (secure digital) card slot 17.

The controller 11 includes a CPU 111, a RAM (random access memory) 112, a ROM (read only memory) 113, and a HDD (hard disk drive) 114. The ROM 113 records various programs and data used by the programs. The RAM 112 is used as a storage area for loading programs and a work area for the loaded programs. The CPU 111 processes the programs loaded in the RAM 112 to implement various functions. The HDD 114 records programs and various data items used by the programs.

The scanner 12 is a hardware element for scanning an original to obtain image data. The printer 13 is a hardware element for printing data onto a sheet. The modem 14 is a hardware element for connecting the image forming apparatus 10 to a telephone line to transmit and receive image data by fax communications. The operation panel 15 is a hardware element including an input unit such as a pointer for receiving input from a user, and a display unit such as a liquid crystal panel. The network interface 16 is a hardware element for connecting the image forming apparatus 10 to a network (wired or wireless) such as a LAN. The SD card slot 17 is used for reading programs recorded in an SD card 80. In the image forming apparatus 10, in addition to programs recorded in the ROM 113, programs recorded in the SD card 80 may also be loaded and executed in the RAM 112. It is to be noted that the SD card 80 may be replaced with other recording media (e.g., a CD-ROM or a USB (Universal Serial Bus) memory). That is, any type of recording medium equivalent to the SD-card 80 may replace the SD card 80. In this case, the SD-card slot 17 may be replaced with hardware corresponding to the type of recording medium.

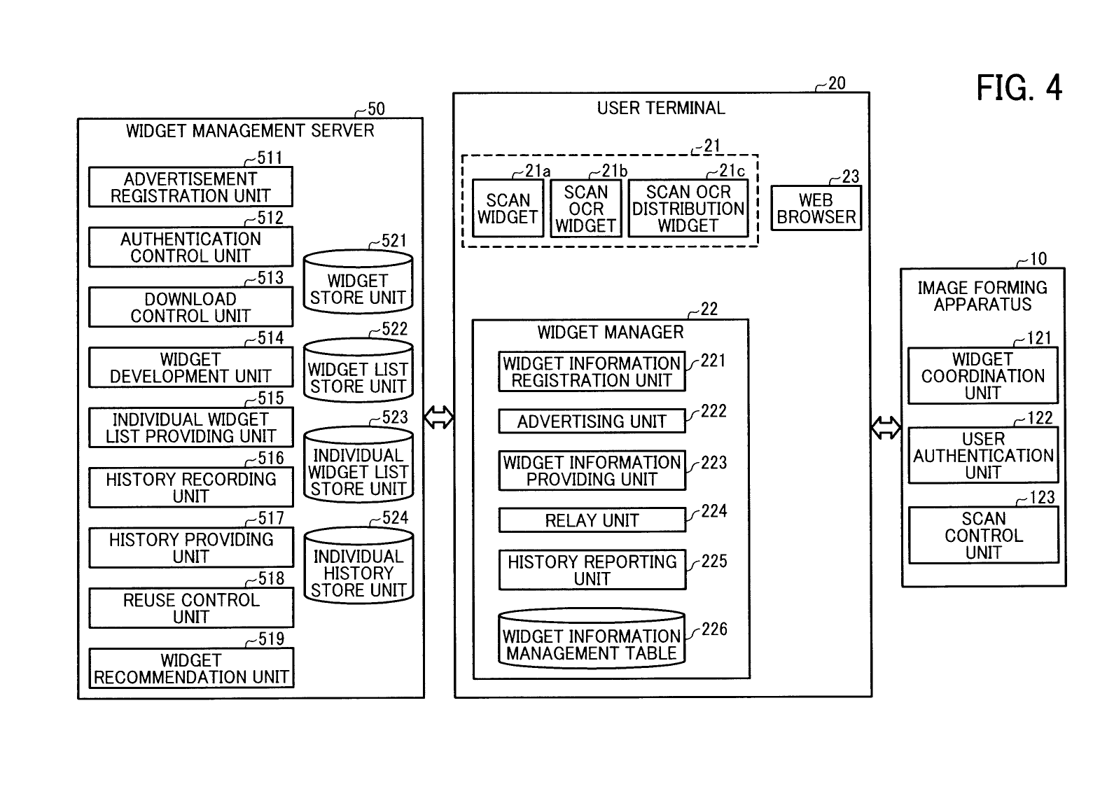

FIG. 4 illustrates a software configuration of the information management system 1 according to an embodiment of the present invention. As shown in FIG. 4, the user terminal 20 includes a scan widget 21a, a scan OCR widget 21b, a scan OCR distribution widget 21c, a widget manager 22, and a Web browser 23.

In the present embodiment, the scan widget 21a, the scan OCR widget 21b, and the scan OCR distribution widget 21c are application programs that may be collectively referred to as widgets 21. In recent years, simple and convenient applications referred to as widgets or gadgets have been available in the market. In the present embodiment, the widgets 21 generally refer to applications that can be easily and conveniently installed and used (thus, the technical scope is not limited by the term “widget”). In the present embodiment, the widgets 21 have a common characteristic in that they cause the image forming apparatus 10 to perform a scan function or execute a process (for example, predetermined process flows) for scanned image data.

The scan widget 21a causes the image forming apparatus 10 to execute a scanning process, and saves the image data obtained as a result of the scanning process in the user terminal 20.

The scan OCR widget 21b causes the image forming apparatus 10 to execute a scanning process, causes the OCR server 60 to execute an OCR process on the image data obtained as a result of the scanning process, and saves the text data obtained as a result of the OCR process in the user terminal 20.

The scan OCR distribution widget 21c causes the image forming apparatus 10 to execute a scanning process, causes the OCR server 60 to execute an OCR process on the image data obtained as a result of the scanning process, and distributes the text data obtained as a result of the OCR process to one or more predetermined addresses. Each of the widgets 21 executes a process independently. The functionalities of the widgets 21 can be expanded with relative ease. For example, the functionality of the scan OCR distribution widget 21c can be expanded to include a translation process on text data obtained as a result of the OCR process and to distribute the text data obtained as a result of the translation process.

The widget manager 22 is positioned as a framework of the widgets 21, and mediates communications between the widgets 21 and the image forming apparatus 10. In one embodiment, the user terminal 20 functions as the widget manager 22. Therefore the widget manager 22 is shared by each of the widgets 21 in the user terminal 20. In another embodiment, the widget manager 22 is installed on a different computer than the computer in which the widgets 21 are installed, and the widget manager 22 uses HTTP (Hyper Text Transfer Protocol) as a communication protocol to communicate with the widgets 21, the image forming apparatus 10, and the widget management server 50.

The widget manager 22 shown in FIG. 4 includes a widget information registration unit 221, an advertising unit 222, a widget information providing unit 223, a relay unit 224, a history reporting unit 225, and a widget information management table 226.

The widget information registration unit 221 receives a request to register widget information (attribute information of a widget 21) from an executed widget 21, and stores the widget information in the widget information management table 226. The widget information management table 226 is a table generated in a storage device of the user terminal 20.

The advertising unit 222 advertises user information by sending an advertisement, including a user ID in the widget information received by the widget information registration unit 221, to the widget management server 50 and each image forming apparatus 10 connected to the network 40. The advertising unit 222 sends the advertisement to each image forming apparatus 10 by, for example, broadcasting or multicasting the user information over the network 40. The advertisement is issued in units of users (in units of user IDs). An advertisement associated with a user A is issued in response to executing a certain widget 21 in the user terminal 20, when another subsequent widget 21 is executed in the same user terminal 20, an advertisement for the subsequent widget 21 is not issued. In the present embodiment, as a matter of convenience, it is assumed that each user terminal 20 corresponds to one user. Therefore, the advertisement issued by the advertising unit 222 is information, that there is a new user executing one of the widgets 21, that is reported to the image forming apparatus 10 or widget management server 50. In another example, the advertisements may be issued in units of widget information items. In this case, plural advertisements may be redundantly issued for the same user; however, the image forming apparatus 10 or the widget management server 50 may eliminate such redundancy.

The widget information providing unit 223 sends widget information registered in the widget information management table 226 in response to a request from the image forming apparatus 10 or the widget management server 50. The relay unit 224 relays communications between a widget 21 and the image forming apparatus 10, or between a widget 21 and the widget management server 50. The history reporting unit 225 reports a history including an execution history of widgets 21 to the widget management server 50.

The Web browser 23 is a common web browser. In the present embodiment, the Web browser 23 is applied as a tool for accessing the a widget management site.

The image forming apparatus 10 includes a widget coordination unit 121, a user authentication unit 122, and a scan control unit 123. A CPU in the image forming apparatus 10 executes programs installed in the image forming apparatus 10 to implement each of these units.

The widget coordination unit 121 operates the widgets 21 from the image forming apparatus 10 and controls execution of a job requested by the widgets 21. The user authentication unit 122 authenticates a user to log into the image forming apparatus 10.

The widget management server 50 includes an advertisement registration unit 511, an authentication control unit 512, a download control unit 513, a widget development unit 514, an individual widget list providing unit 515, a history recording unit 516, a history providing unit 517, a reuse control unit 518, a widget recommendation unit 519, a widget store unit 521, a widget list store unit 522, an individual widget list store unit 523, and an individual history store unit 524. The CPU 504 in the widget management server 50 executes programs installed in the widget management server 50 to implement each of these units.

The advertisement registration unit 511 receives an advertisement from the widget manager 22, and stores information included in the advertisement to the memory device 503 or the secondary storage device 502. The authentication control unit 512 authenticates a user accessing the widget management server 50 via the network 70. The download control unit 513 controls downloading of a widget entity to the user terminal 20. For example, the widget entity is a file including a widget 21 and the attribute information of the widget 21. The widget development unit 514 assists in adding or improving functions of a widget. The individual widget list providing unit 515 provides a list of widgets 21 stored in the individual widget list store unit 523. The individual widget list store unit 523 exists in units of users. Further, the individual widget list store unit 523 stores a list of downloaded widgets 21 corresponding to each user to the secondary storage device 502. The history recording unit 516 records the execution history of widgets 21 in units of users to the individual history store unit 524. The individual history store unit 524 exists in units of users. And the individual history store unit 524 stores the execution history of widgets 21 corresponding to each user to the secondary storage device 502. The history providing unit 517 provides the history stored in the individual history store unit 524. The reuse control unit 518 controls reuse of the history stored in the individual history store unit 524. The widget recommendation unit 519 recommends one or more widgets to a user based on a widget used by the user and one or more widgets used by another user who also uses the same widget.

Therefore, the widget store unit 521 and the widget list store unit 522 are shared by all users. The individual widget list store unit 523 and the individual history store unit 524 exist in units of users.

A description is now given of a process performed by the information management system 1. In the present embodiment, a description is given of an example using the scan OCR distribution widget 21c.

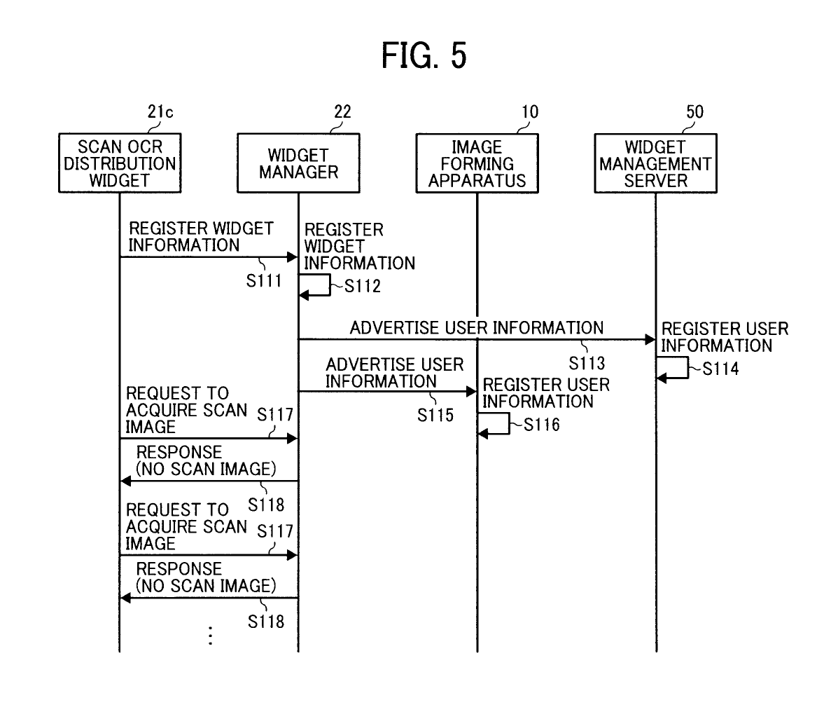

FIG. 5 is a sequence diagram of processing procedures that are performed when widget registration information is sent.

When the scan OCR distribution widget 21c is activated in response to an instruction input by a user, the scan OCR distribution widget 21c acquires widget information from an attribute information management file and sends the widget information to the widget manager 22 (step S111). In advance, each widget 21 stores information to communicate with the widget manager 22 (for example, a URL (Uniform Resource Locator) of the widget manager 22).

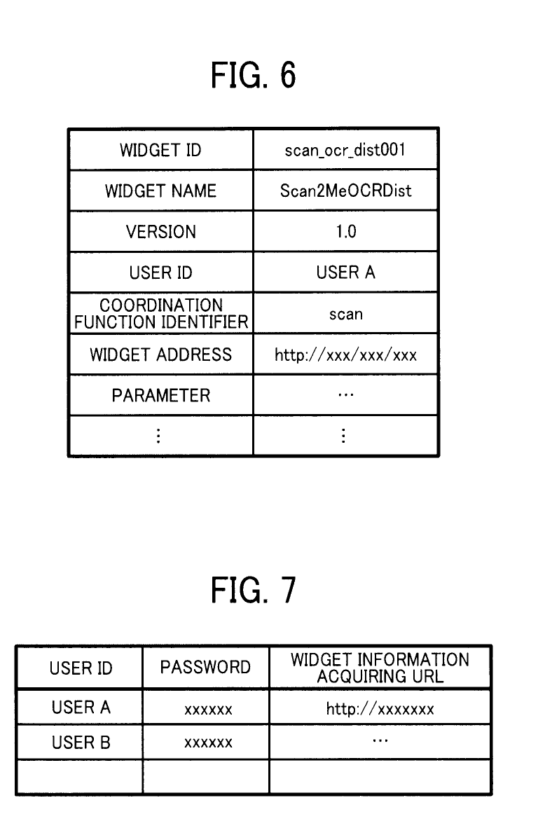

FIG. 6 illustrates an example of widget information of the scan OCR distribution widget 21c. As shown in FIG. 6, the widget information of the scan OCR distribution widget 21c includes a widget ID, a widget name, a version, a user ID, a coordination function identifier, a widget address, and one or more parameters.

The widget ID is identification information for uniquely identifying each widget 21. The widget name is a character string for the widget 21. The version is a number that is used to distinguish between widgets having the same widget ID and widget name. The user ID is an identifier of a user of the widget 21. The coordination function identifier is information for identifying a function included in the image forming apparatus 10 by the widget 21. Examples of the coordination function identifier are “print” and “scan”. “Print” indicates a print function. “Scan” indicates a scan function. The scan OCR distribution widget 21c uses the scan function of the image forming apparatus 10. Therefore, in the example shown in FIG. 6, “scan” is indicated as the coordination function identifier. The widget address is identification information (for example, a URL) for uniquely identifying each widget 21 in network communications. The one or more parameters are used to decide a behavior corresponding to each widget 21. For example, the one or more parameters of the scan OCR distribution widget 21c includes scan setting information, an identifier to execute for OCR web service (like URL), and an identifier to send an OCR result (like an e-mail address).

The widget information from the scan OCR distribution widget 21c is received by the widget information registration unit 221 of the widget manager 22 (step S111). The widget information registration unit 221 registers the widget information in the widget information management table 226 corresponding to a user ID included in the widget information (step S112). When there is no widget information management table 226 that corresponds to the user ID, the widget information registration unit 221 generates the widget information management table 226 corresponding to the user ID, and registers the widget information in the generated widget information management table 226 (step S112).

When a new widget information management table 226 is generated (that is to say, when widget information is registered for the first time for the user corresponding to the user ID included in the received widget information), the advertising unit 222 of the widget manager 22 sends an advertisement including the user ID, a password, and a URL for acquiring widget information included in the received widget information to the widget management server 50 by unicast (step S113). Therefore, the widget manager 22 istores a URL for the advertisement registration unit 511 of the widget management server 50 in advance. For example, the widget manager 22 also stores the user ID and the password corresponding to a login user ID and a login password of the user terminal 20.

The URL for acquiring widget information (hereinafter, “widget information acquiring URL”) is unique to each widget information management table 226. For example, the widget information registration unit 221 generates the widget information acquiring URL corresponding to the widget information management table 226, when the widget information registration unit 221 generates the widget information management table 226 for a respective user. Therefore the widget information acquiring URL is unique to each user terminal 20.

The advertisement registration unit 511 registers the user ID, a password, and the widget information acquiring URL to an active user list, if the advertisement registration unit 511 receives the advertisement.

FIG. 7 illustrates an example of the active user list. As shown in FIG. 7, a record corresponding to each user executing some widgets 21 is included in the active user list, and the record includes the user ID, the password, and the widget information acquiring URL. In the example shown in FIG. 7, the records are registered with respect to a user A and a user B. For example, the active user list is generated in the secondary storage device 502, or the memory device 503.

Next, the advertising unit 222 advertises user information. In step S113 the user information is advertised to the widget management server 50, which registers the user information in step S114. Further, the advertising unit 222 broadcasts or multicasts an advertisement on the network 40 in step S115. In other words, the advertisement is sent to unspecified image forming apparatuses 10. The widget coordination unit 121 of an image forming apparatus 10 receives the advertisement, and registers the user ID, a password, and the widget information acquiring URL to an active user list (step S116). The active user list is similar to the list shown in FIG. 7 to be generated in the RAM 112 or the HDD 114.

However, the active user list of the image forming apparatus 10 (hereinafter, “apparatus active user list”) is only registered to apply the advertisement of the user terminal 20 in the user environment 2. On the other hand, the active user list of the widget management server 50 (hereinafter, “server active user list”) is registered to apply all the advertisements including the user terminal 20 in user environment 2.

The scan OCR distribution widget 21c polls the widget manager 22 to confirm whether image data has been obtained by a scanning process at the image forming apparatus 10. Specifically, the scan OCR distribution widget 21c sends a request to acquire image data obtained by a scanning process (scan image data) to the relay unit 224 of the widget manager 22 (step S117). The relay unit 224 responds to the acquiring request (step S118). Image data is not obtained by a scanning process at this point, and therefore a response indicating that there is no scan image data is returned from the relay unit 224. Subsequently, the request to acquire the scan image data is performed at certain intervals. The request to acquire the scan image data includes the widget ID to distinguish the widget 21 sending the request to acquire the scan image data.

A processing procedure similar to the one shown in FIG. 5 is performed, if the scan widget 21a or the scan OCR widget 21b is executed. When executed, the widget information of the scan widget 21a or the scan OCR widget 21b is registered in the widget management table 226. However, an advertisement associated with the same user is not issued because the advertisement had previously been issued in response to the execution of the scan OCR distribution widget 21c.

Each widget 21 sends a quit request including the widget ID, the widget name, the version, and the user ID to the widget manager 22 during a processing procedure if the widget quits (stops executing). In essence, the widget information management table 226 registers the widget information of the executing widgets.

After the process of FIG. 5, the user moves to the location where the image forming apparatus 10 is installed to operate the scan OCR distribution widget 21c. When plural image forming apparatuses 10 are able to communicate with the user terminal 20, each user authentication unit 122 of the image forming apparatuses 10 receives the advertisement to register the user ID and the widget information acquiring URL to the active user list corresponding to the respective one of the plural image forming apparatuses 10. Therefore, the user can operate the scan OCR distribution widget 21c by going to the desired image forming apparatus 10 among plural image forming apparatuses 10.

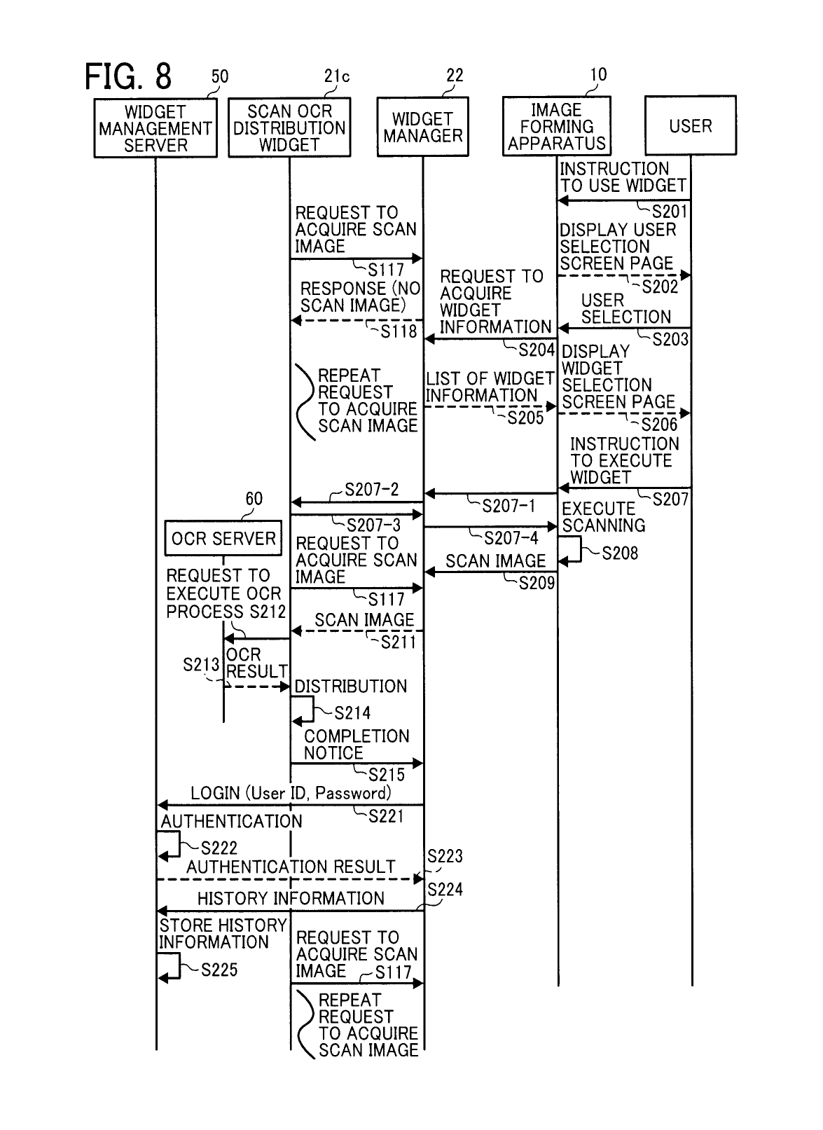

Next, a description is given of a process executed according to user operation of the image forming apparatus 10. FIG. 8 is a sequence diagram of processing procedures that are performed when executing a process flow of the scan OCR distribution widget 21c.

When a user inputs an instruction via the operation panel 15 (step S201), widget coordination unit 121 of the image forming apparatus 10 causes the operation panel 15 to display a user selection screen page based on an active user list (step S202).

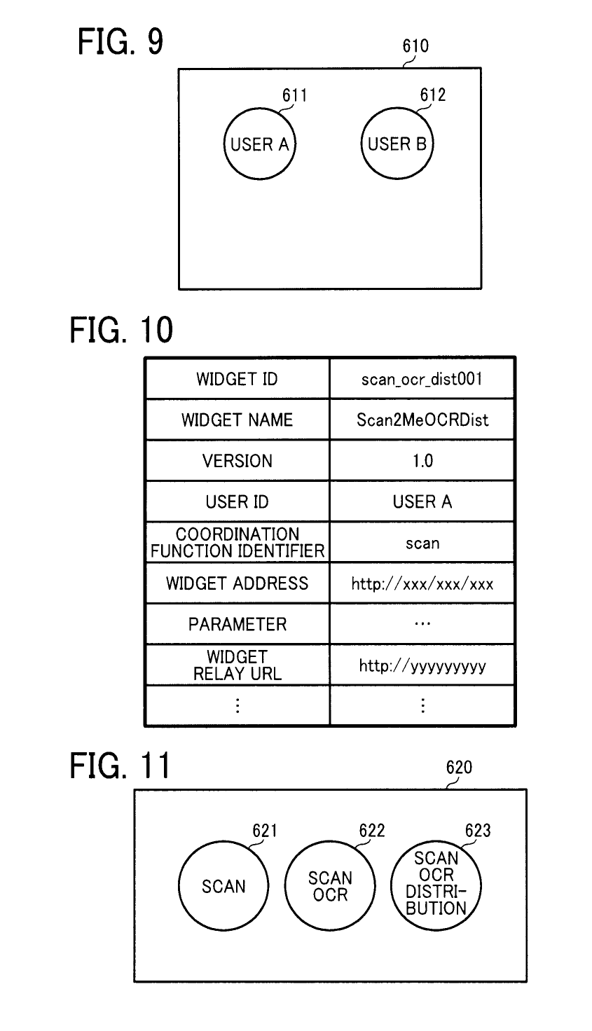

FIG. 9 illustrates an example of a displayed user selection screen page 610. The user selection screen page 610 shown in FIG. 9 includes buttons that each correspond to a user ID. In FIG. 9, a button 611 corresponding to a user A and a button 612 corresponding to a user B are displayed.

Next, the user presses a button corresponding to his or her own user ID in the user selection screen page 610 (step S203). As the button is pressed, the widget coordination unit 121 acquires the user ID and the password corresponding to the selected button from the apparatus active user list. Then, the widget coordination unit 121 causes the user authentication unit 122 to authenticate the user based on the acquired user ID and the password. If the user is authenticated, the widget coordination unit 121 acquires the widget information acquiring URL associated with the user ID from the apparatus active user list. Next, the widget coordination unit 121 sends a request to acquire the widget information to the widget information acquiring URL (step S204).

The request to acquire widget information is received by the widget information providing unit 223 of the widget manager 22. The widget information providing unit 223 acquires a list of widget information registered in widget information management table 226 corresponding to the widget information acquiring URL (that is to say, the user operating the image forming apparatus 10), and sends the list of widget information items to the image forming apparatus 10 (step S205). When sending the list of widget information items, the widget information providing unit 223 generates a unique URL (hereinafter, “widget relay URL”) for each widget 21 (each widget information item) to relay communications between the image forming apparatus 10 and each widget 21. The widget information providing unit 223 sends the widget information with an attached widget relay URL corresponding to each widget 21 to the image forming apparatus 10.

FIG. 10 illustrates an example of the widget information that is sent in step S205. The widget information shown in FIG. 10 is formed by attaching a widget relay URL to the widget information shown in FIG. 6. In step S205, a list of widget information items shown in FIG. 10 is sent to the image forming apparatus 10. The list of widget information items may include one or more widget information items.

The widget coordination unit 121 of the image forming apparatus 10 records the received list of widget information items in the RAM 112, and displays a screen page (widget selection screen page) including a list of widgets 21 that can be used by the user (step S206).

FIG. 11 illustrates an example of a displayed widget selection screen page 620. The widget selection screen page 620 shown in FIG. 11 includes buttons that each correspond to a widget 21. In FIG. 11, a button 621 corresponding to the scan widget 21a, a button 622 corresponding to the scan OCR widget 21b, and a button 623 corresponding to the scan OCR distribution widget 21c are displayed.

If a user selects the button 623 corresponding to the scan OCR distribution widget 21c in the widget selection screen page 620 and sets an original in the image forming apparatus 10 (step S207), the widget coordination unit 121 recognizes that scanning is to be executed, based on the coordination function identifier (“scan”) included in the widget information corresponding to the pressed button (hereinafter, “current widget information”). As illustrated in FIG. 8, the processing of the instruction to execute the widget in step S207 includes steps S207-1 to S207-4. The widget coordination unit 121 requests the scan control unit 123 to execute scanning.

The scan control unit 123 controls the operation of scanning an original to obtain image data, based on the scan setting information of the parameters included in the current widget information (step S208). More specifically, the scan control unit 123 causes the scanner 12 to scan an original, and outputs the image data obtained as a result of the scanning process to the widget coordination unit 121.

The widget coordination unit 121 sends the image data to a widget relay URL included in the current widget information (step S209). The parameters included in the current widget information are sent to the widget relay URL with the image data. For example, the scan setting information may be provided to the widget 21, if the scan setting information can be changed in the widget selection screen page 620 after selecting the widget 21. The changed scan setting information may expire at the end of one job.

The image data and the parameters sent to the widget relay URL are received by the relay unit 224 of the widget manager 22. The relay unit 224 stores the image data and the parameters in association with the widget information management table 226 corresponding to the widget relay URL (that is to say, the widget information management table 226 corresponding to the scan OCR distribution widget 21c).

After scan image data has been received, the relay unit 224 returns the image data and the parameters associated with the widget information management table 226 to the scan OCR distribution widget 21c (step S211) as a response to the request to acquire scan image data (step S117).

In response to receiving the scan image data and parameters, the scan OCR distribution widget 21c sends the scan image data to the OCR server 60 to execute an OCR process (step S212). The OCR server 60 is determined by the received parameters. Specifically, the parameters include the URL to execute for OCR web service.

The OCR server 60 executes an OCR process on the scan image data, and returns text data as an execution result of the OCR process (hereinafter, “OCR result data”) to the scan OCR distribution widget 21c (step S213). The scan OCR distribution widget 21c distributes the OCR result data to an e-mail address included in the parameters (step S214). Next, the scan OCR distribution widget 21c sends a completion notice including the OCR result data to the widget manager 22 (step S215). After sending the completion notice, the scan OCR distribution widget 21c resumes polling in order to be prepared for the next operation.

On the other hand, the relay unit 224 of the widget manager 22 associates the OCR result data with the widget information management table 226 corresponding to the scan OCR distribution widget 21c, and stores the received OCR result data with the completion notice. Next, the history reporting unit 225 of the widget manager 22 reports the execution history of the scan OCR distribution widget 21c. For example, the history reporting unit 225 sends a login request specifying the stored user ID and the stored password to the widget management server 50 (step S221).

The authentication control unit 512 in the widget management server 50 authenticates the user based on the specified user ID and the specified password in response to the login request (step S222). If the authentication is successful, the user is accepted as a login user and the authentication control unit 512 generates a session ID corresponding to the login user, and returns an authentication result with the session ID to a history reporting unit 225 (step S223). If the authentication is not successful, the returned authentication result excludes the session ID.

If the authentication result is successful, the history reporting unit 225 sends history information to the widget management server 50 specified by the session ID (step S224). The history information includes the widget ID, the widget name, the version, and the parameters of the widget information management table 226 corresponding to the scan OCR distribution widget 21c, and further includes the scan image data and the OCR result data associated with the widget information management table 226.

The history recording unit 516 in the widget management server 50 records the received history information to the individual history store unit 524 depending on the login user corresponding to the session ID (step S225).

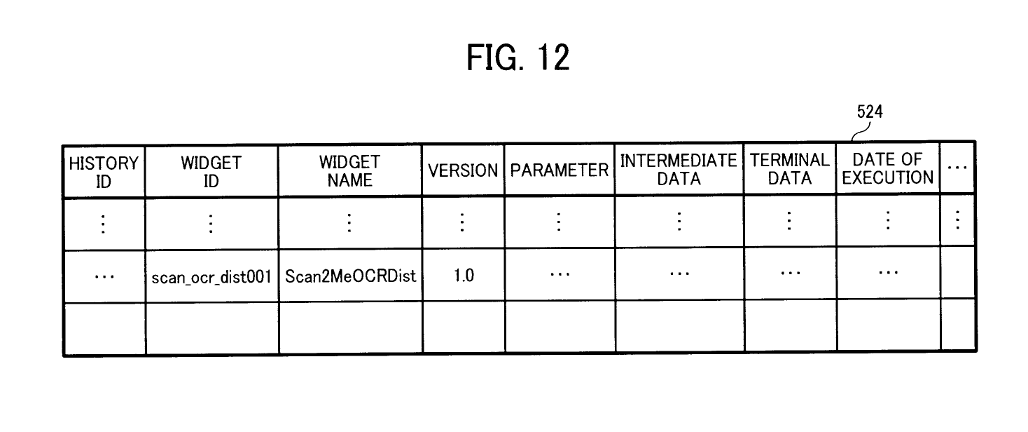

FIG. 12 illustrates an example of the individual history store unit 524. As shown in FIG. 12, the individual history store unit 524 stores a history ID, a widget ID, a widget name, a version, parameters, intermediate data, terminal data and a date of execution. The widget ID, the widget name, the version, the parameters, the intermediate data and the terminal data are included in the history information. More specifically, file names for the intermediate data and the terminal data are recorded instead of the real intermediate data and the real terminal data stored in the secondary storage device 502. The intermediate data refers to data generated intermediately during the execution of the widget 21. In the case of the scan OCR distribution widget 21c, the scan image data corresponds to the intermediate data. Further, plural intermediate data may be generated. For example, if the scan OCR distribution widget 21c additionally translates the OCR result data after the OCR process, the OCR result data is also intermediate data. The terminal data refers to data generated terminally during the execution of the widget 21. That is, the terminal data corresponds to data that is generated by the widget 21 when the processing to be performed by the widget 21 is completed. In the case of the scan OCR distribution widget 21c, the OCR result data corresponds to the terminal data.

The history ID is an identifier for uniquely identifying each history entry. The date of execution is the date and time the widget 21 was executed. According to the present embodiment, the date of execution corresponds to a date when the history recording unit 516 records a history information. The date of execution may be sent by the history reporting unit 225 of the widget manager 22 in the same way as other information.

Therefore, the widget management server 50 integrally stores the execution history of widgets 21 corresponding to each user. For example, whenever a user executes the scan OCR distribution widget 21c in the user terminal 20, the same widget management server 50 stores the history information as an execution history.

If the scan widget 21a is executed, a similar processing procedure shown in FIG. 8 is performed without steps S212 to S214. If the scan OCR widget 21b is executed, a similar processing procedure shown in FIG. 8 is performed without step S214.

Next, a description is given of a process executed to download a widget 21 into the user terminal 20. Each widget in the user terminal 20 is available when the widget 21 is downloaded from the widget management server 50 into the user terminal 20.

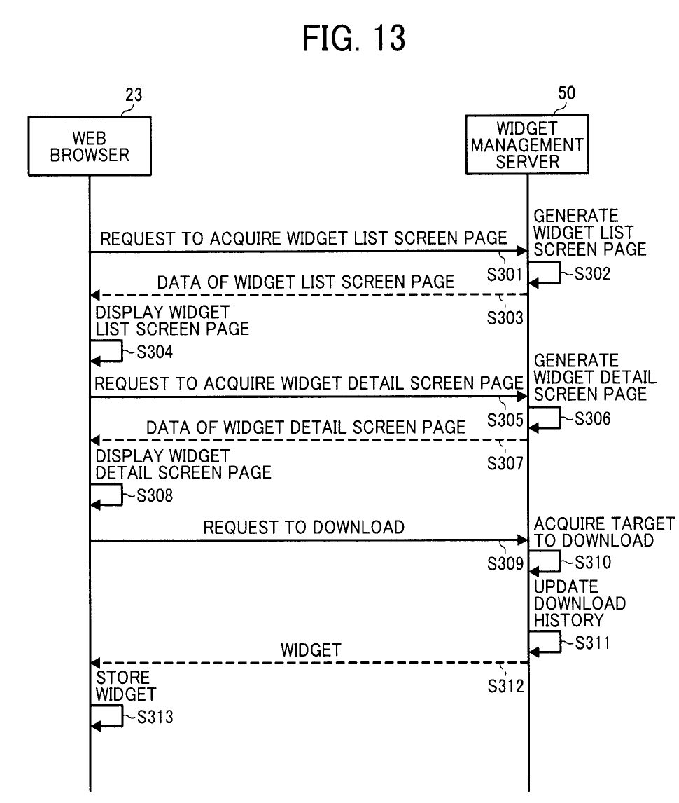

FIG. 13 is a sequence diagram of processing procedures that are performed when downloading a widget 21. This description is based on the premise that the user already has logged into the widget management site in the widget management server 50 from the user terminal 20. In response to inputting a user ID and a password into a login screen page in the Web browser 23 to log into the widget management site, the authentication control unit 512 in the widget management server 50 authenticates the user based on the inputted user ID and the inputted password. If the authentication is successful, the user is accepted as a login user. And, the authentication control unit 512 generates a session ID corresponding to the login user and returns an authentication result with the session ID to the Web browser 23. Thereafter, the Web browser 23 issues requests with the session ID to the widget management server 50.

In response to a command to display a widget list screen page in a page screen provided by the widget management site in the Web browser 23 by the user (for example, by selecting the hyperlink in a certain page screen), the Web browser 23 sends a request to acquire the widget list screen page to the widget management server 50 (step S301). The widget list screen page is a page screen (web page) that displays a list of downloadable widgets. In response to the request to acquire the widget list screen page, the download control unit 513 generates display data (HTML data) to display the widget list screen page by referring to the widget list store unit 522 (step S302).

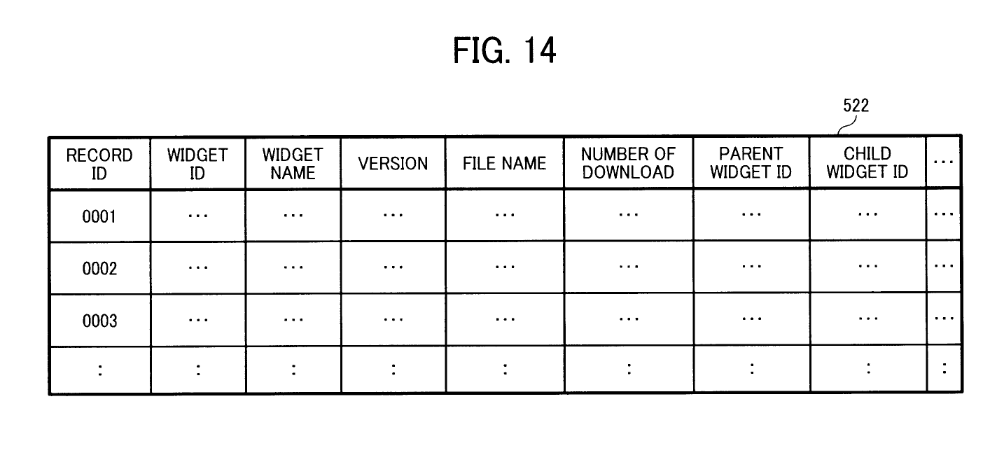

FIG. 14 illustrates a configuration of a widget list store unit 522. The widget list store unit 522 shown in FIG. 14 stores a record including a record ID, a widget ID, a widget name, a version, a file name, a number of downloads, a parent widget ID, and a child widget ID corresponding to each downloadable widget 21 stored in the widget store unit 521.

The widget ID, the widget name and the version are similar to the preceding description. The record ID is an identifier for uniquely identifying each record in the widget list store unit 522. The record is definitive information for uniquely identifying each widget 21. In contrast with the record IDs which do not overlap, it is acceptable to make widgets having overlapping widget IDs, overlapping widget names and overlapping versions. However, in the present embodiment, as a matter of convenience, it is assumed that the widget is uniquely identified by a combination of widget ID, widget name and version.

The file name is information to locate the actual widget 21 file in the widget store unit 521. The number of downloads represents the number of times the widget has been downloaded before. The parent widget ID or the child widget ID is relationship information based on common functions between the widget and another widget. If a certain widget 21 does not have a relationship with another widget 21, the parent widget ID and the child widget ID of the certain widget are null values. A relationship between widgets is generated when a certain widget 21 is upgraded (hereinafter, “case 1”), or is associated with a recommended widget (hereinafter, “case 2”).

In the case 1, the certain widget 21 becomes the parent widget, and the upgraded widget 21 becomes the child widget. For example, the certain widget 21 may be upgraded by the author of the certain widget 21. If the certain widget 21 is upgraded, the upgraded widget 21 is stored in the widget store unit 521 (for example, by uploading), and the record corresponding to the upgraded widget 21 is stored in the widget list store unit 522. Next, the child widget ID corresponding to the certain widget 21 is registered in the record ID corresponding to the upgraded widget 21, and the parent widget ID corresponding to the upgraded widget 21 is registered in the record ID corresponding to the certain widget 21 in the widget list store unit 522.

In the case 2, the certain widget 21 associated with a recommended widget becomes the parent widget, and the recommended widget becomes the child widget. The recommended widget is a widget 21 that is recommended to a user using the certain widget. For example, the recommended widget is associated by an administrator of the widget management server 50 or by the widget recommendation unit 519, automatically. The widget recommendation unit 519 decides the recommended widget in the same way as processing procedures of heretofore known (for example, an online bookstore).

For example, the widget recommendation unit 519 extracts frequently-downloaded widgets together from the individual widget list store unit 523. Further, one of the frequently-downloaded widgets is associated with another widget as the recommended widget. If the recommended widget 21 is associated with the certain widget, the child widget ID corresponding to the certain widget is registered in the record ID corresponding to the recommended widget 21, and the parent widget ID corresponding to the recommend widget 21 is registered in the record ID corresponding to the certain widget in the widget list store unit 522.

However, the relationship based on the recommended widget may be stored separately from the parent-child relationship based on the upgraded widget if the common functions between the certain widget and the recommended widget are not maintained. Specifically, a recommended widget ID may be added to the record in the widget list store unit 522.

Back to FIG. 13, the download control unit 513 generates data of the widget list screen page to download each widget registered in the widget list store unit 522 (step S302). Next, the download control unit 513 sends the data of the widget list screen page to the Web browser 23 (step S303). The Web browser 23 displays the widget list screen page based on the received data of the widget list screen page (step S304).

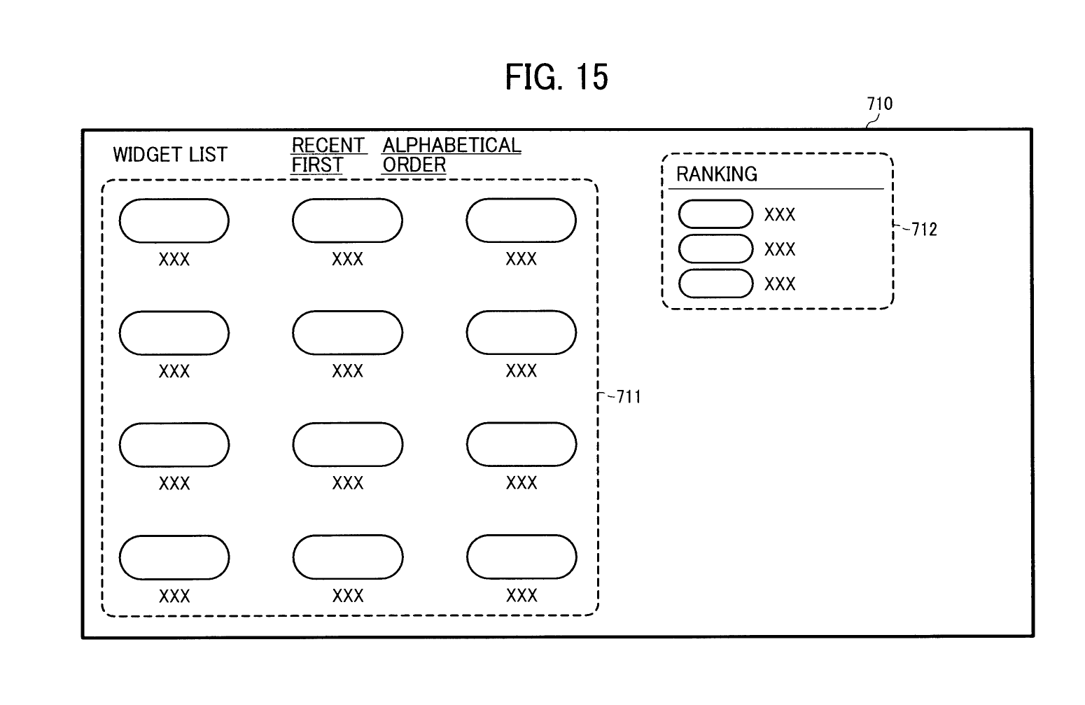

FIG. 15 illustrates an example of a displayed widget list screen page 710. An area 711 of the widget list screen page 710 displays an icon and the widget name for each downloadable widget. For example, the icon is acquired from the attribute information of the respective widget 21 in the widget store unit 521. An area 712 displays a download ranking with the icon and the widget name. For example, an area that displays an evaluation ranking or an area that displays advertisements for widgets that may be added to the widget list screen page 710 to manage feedback from users.

If one of the icons or the widget names is selected in the area 711 or the area 712 in the widget list screen page 710, the Web browser 23 sends a request to acquire a widget detail screen page based on a hyperlink corresponding to the selected icon or the widget name to the widget management server 50 (step S305). The request to acquire the widget detail screen page specifies the record ID corresponding to the selected widget 21. In response to the request, the download control unit 513 acquires a file name corresponding to the specified record ID from the widget list store unit 522, and acquires the actual widget 21 corresponding to the file name from the widget store unit 521.

Next, the download control unit 513 generates data of a widget detail screen page from the attribute information management file of the acquired widget 21 (step S306). The download control unit 513 returns the data of the widget detail screen page to the Web browser 23 (step S307). The Web browser 23 displays the widget detail screen page based on the received data (step S308).

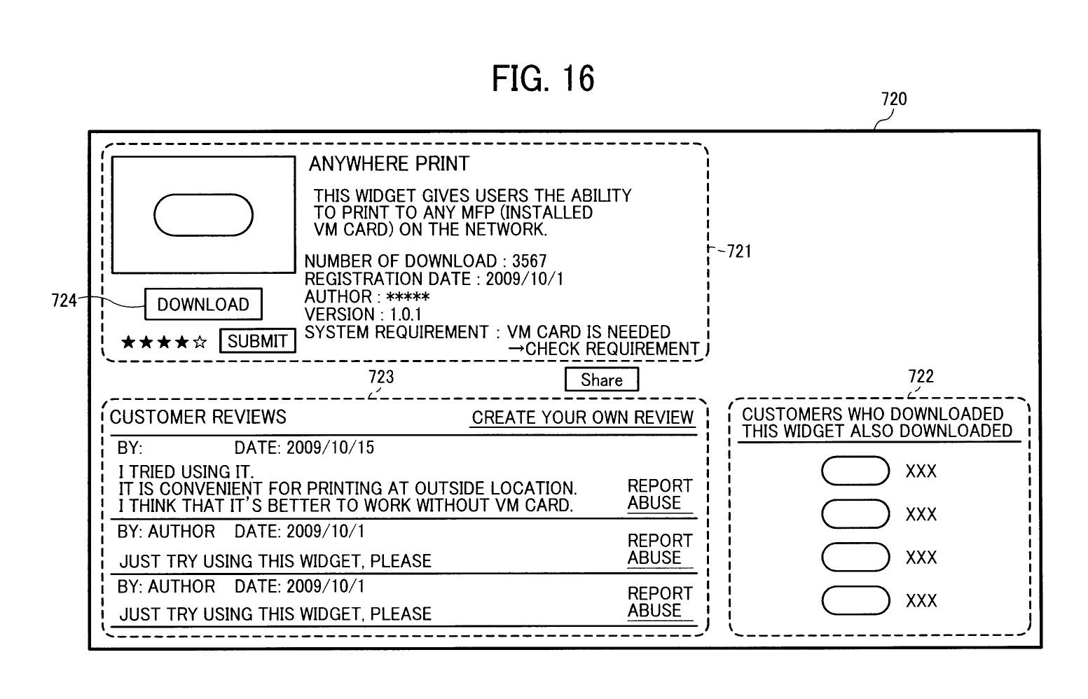

FIG. 16 illustrates an example of a displayed widget detail screen page 720. An area 721 in the widget detail screen page 720 displays an icon, a description of functions, and other information for the widget 21 selected in the widget list screen page 710 (hereinafter, a “target widget”). The information are acquired from the attribute information of the target widget 21. An area 722 displays a list of recommended widgets corresponding to the target widget. The recommended widgets are selected at least based on relationships (e.g., parent-child relationships) with the target widget 21 in the widget list store unit 522. Therefore, an upgraded widget 21 may be displayed in the area 722. An area 723 displays customer reviews from users of the target widget 21. For example, the customer reviews are inputted in a review screen page, and stored in association with each widget in the secondary storage device 502 of the widget management server 50.

In response to a selection, for example by clicking, of the download button 724 in the area 721 of the widget detail screen page 720, the Web browser 23 sends a request to download the target widget 21 specifying the record ID (step S309). In response to the request to download, the download control unit 513 acquires a file name corresponding to the specified record ID in the widget list store unit 522, and acquires the actual widget 21 corresponding to the file name from the widget store unit 521 (step S310). Further, the download control unit 513 increases the number of downloads corresponding to the specified record ID in the widget list store unit 522.

Next, the download control unit 513 acquires a record corresponding to the specified record ID in the widget list store unit 522, and stores a part of the record in a download history corresponding to the login user in the individual widget list store unit 523 (step S311). Further the actual widget 21 is sent to the Web browser 23 (step S312), which stores the widget (step S313).

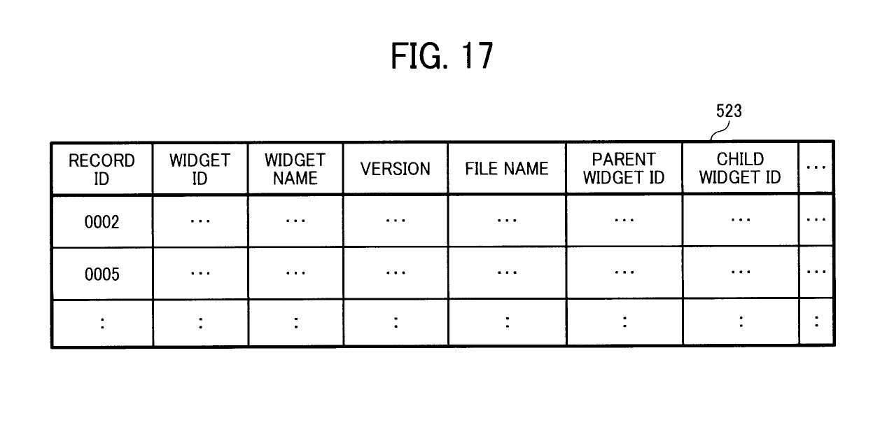

FIG. 17 illustrates a configuration of an individual widget list store unit 523. The individual widget list store unit 523 shown in FIG. 17 is similar to the preceding description of the widget list store unit 522, without the number of downloads. However, the individual widget list store unit 523 differs in two respects from the widget list store unit 522. First, the individual widget list store unit 523 is user specific. Second, the individual widget list store unit 523 stores information corresponding to a widget which the user downloads. In other words, information stored in the individual widget list store unit 523 corresponds to a download history associated with the user.

Each item of the record corresponding to a record ID stores the same values as the widget list store unit 522 except for the parent widget ID and the child widget ID.

The properties of the parent widget and the child widget in the individual widget list store unit 523 differ from the properties of the parent widget and the child widget in the widget list store unit 522. Specifically, a relationship between widgets in the individual widget list store unit 523 is generated when a parameter of a certain widget 21 is changed, for example, when a derivation widget is created. In this case, the certain widget 21 before being changed (hereinafter, a source widget) becomes the parent widget, and the certain widget 21 after being changed (hereinafter, a derivation widget) becomes the child widget. Common functions between the source widget and the derivation widget are maintained because the derivation widget has a similar processing procedure as the source widget. The derivation widget is made by a user as will hereinafter be described in detail.

If a derivation widget 21 is made, the derivation widget is uploaded to and stored in the widget store unit 521, and the record corresponding to the derivation widget is stored in the individual widget list store unit 523. Next, the child widget ID corresponding to the source widget is registered with the record ID corresponding to the derivation widget, and the parent widget ID corresponding to the derivation widget is registered with the record ID corresponding to the source widget in the widget list store unit 522.

The download control unit 513 sends the derivation widget. As a result, the derivation widget is available in the user terminal 20.

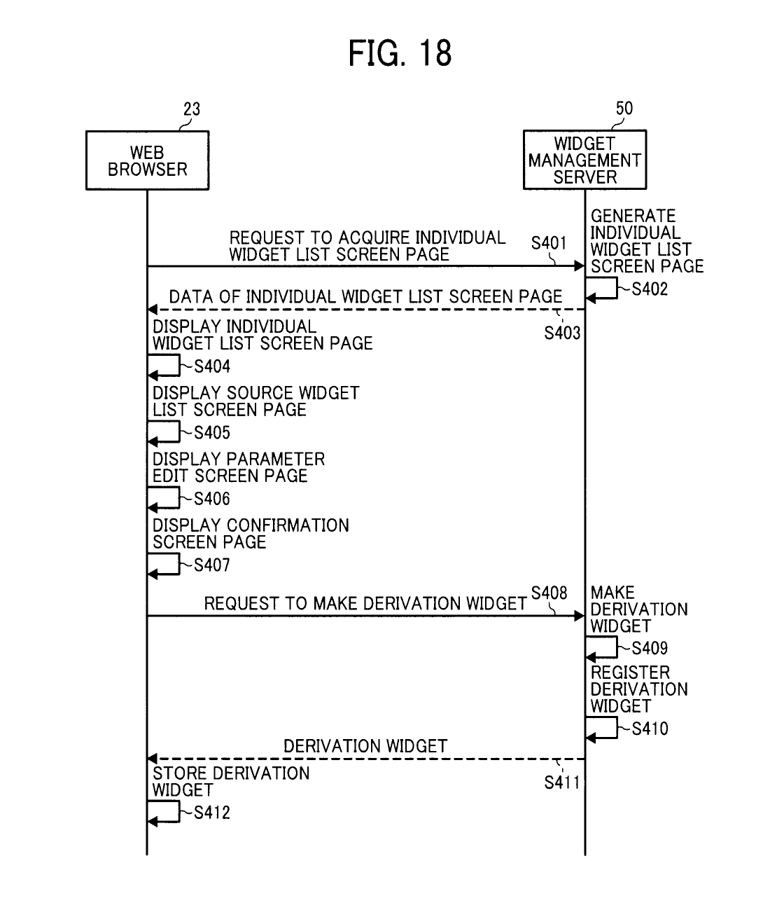

Next, a description is given of a process of making the derivation widget. FIG. 18 is a sequence diagram of processing procedures that are performed when making the derivation widget. Similar to FIG. 17, this description is made based on the premise that the user already has logged in from the user terminal 20 into the widget management site in the widget management server 50.

In response to a command to display an individual widget list screen page on a page screen provided on the widget management site in the Web browser 23 by the user (for example, by selecting the hyperlink in a certain page screen), the Web browser 23 sends a request to acquire the individual widget list screen page to the widget management server 50 (step S401). Next, the individual widget list providing unit 515 in the widget management server 50 generates display data (HTML data) to display the individual widget list screen page with reference to the individual widget list store unit 523 (shown in FIG. 17) corresponding to the login user (step S402). The Web browser 23 displays the individual widget list screen page based on the received data (step S403) of the individual widget list screen page (step S404)

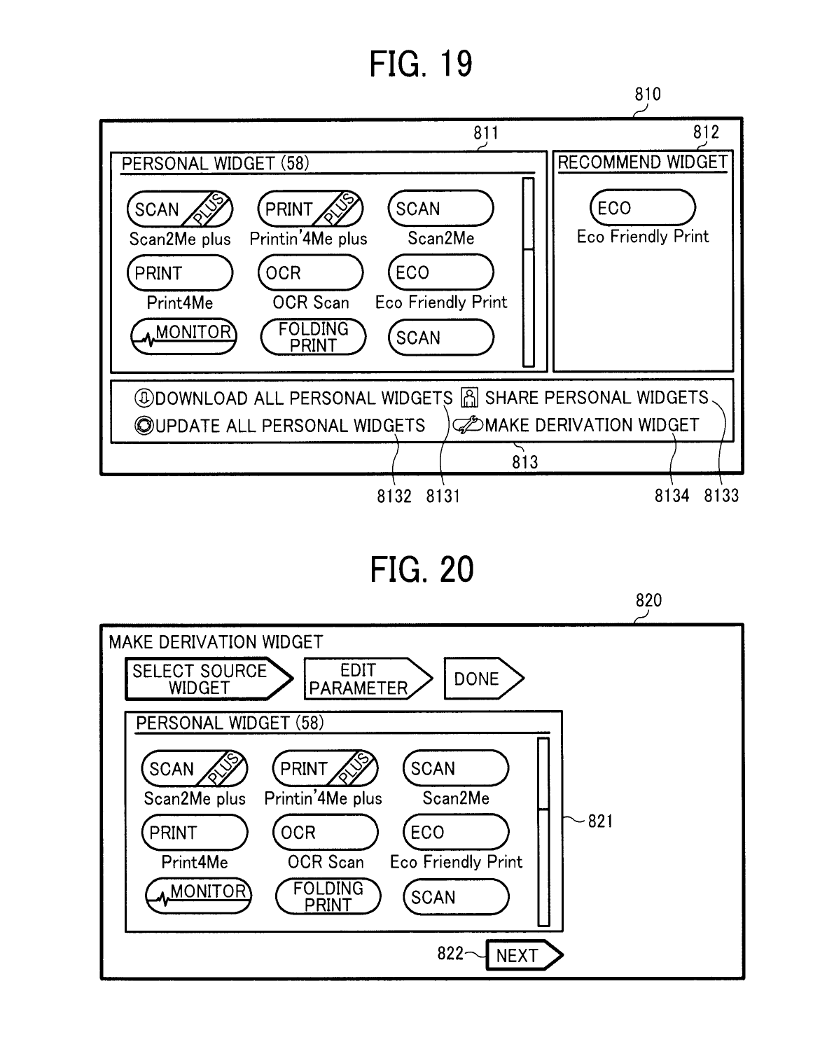

FIG. 19 illustrates an example of a displayed individual widget list screen page 810. An area 811 of the widget list screen page 810 displays the icons and the widget names of downloaded widgets 21 for the login user. In other words, the area 811 displays a list of widgets in the individual widget list store unit 523 associated with the login user (hereinafter, “personal widget”). A list of recommended widgets corresponding to the login user is displayed in an area 812. The recommended widgets have a relationship with the personal widgets of the login user in the widget list store unit 522.

An area 813 includes some hyperlinks for, for example, managing the personal widgets or accepting other commands. In response to the selection of a hyperlink 8134 (“MAKE DERIVATION WIDGET”), a select source widget screen page is displayed (step S405).

FIG. 20 illustrates an example of a displayed source widget list screen page 820. The source widget list screen page 820 is a display to select a source widget to make a derivation widget. A list of personal widgets is displayed in an area 821 as prospective source widgets. If the user selects one of the personal widgets in the area 821 as a source widget and clicks a next button 822, an edit parameter screen page is displayed in the Web browser (step S406).

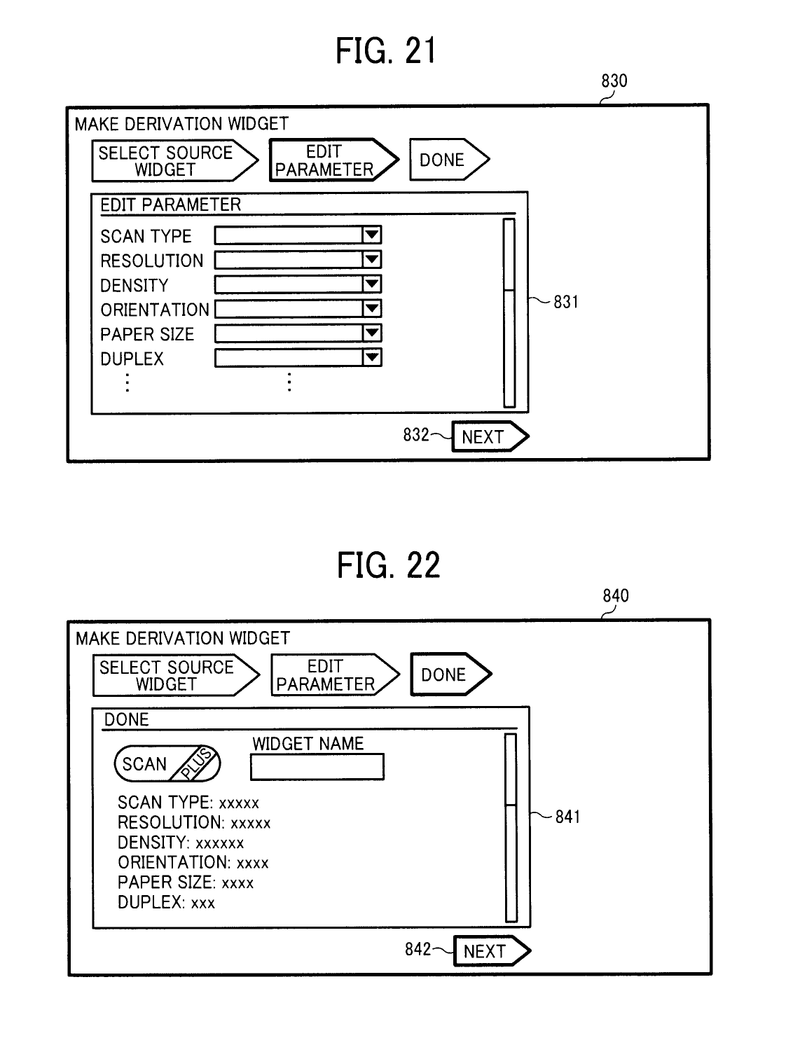

FIG. 21 illustrates an example of an edit parameter screen page 830. The edit parameter screen page 830 provides an interface for editing parameters for a derivation widget. An area 831 includes input areas corresponding to each of the items for parameters of the source widget. A value inputted at the input area is set as the parameter for the derivation widget. A value for the source widget may be displayed as a default parameter for the derivation widget. Therefore, a burden to change only a subset of the parameters is decreased. If the user sets values in area 831 as parameters and clicks a next button 832, a confirmation screen page is displayed in the Web browser (step S407).

FIG. 22 illustrates an example of a displayed confirmation screen page 840. The confirmation screen page 840 is a display to confirm information such as the selected source widget or the edited parameters. This information was inputted into the edit parameter screen page 830. An area 841 includes a text box to input a widget name for the derivation widget. If the user sets the widget name in the text box and clicks a next button 842, the Web browser 23 send a request to make the derivation widget to the widget management server 50 (step S408). The request to make the derivation widget includes the record ID of the source widget, the parameters inputted in the edit parameter screen page 830, and the widget name inputted in the confirmation screen page 840.

Specifically, the Web browser 23 communicates to the widget management server 50 with each transition of screens among the source widget list screen page 820, the edit parameter screen page 830, and the confirmation screen page 840. Therefore, information inputted until then may be sent to the widget management server 50 with each communication.

In response to the request, the widget development unit 514 in the widget management server 50 makes a derivation widget based on information included in the request to make the derivation widget. Specifically, the widget development unit 514 acquires a file name corresponding to the record ID of the source widget included the request, and makes a copy of the actual widget 21 (including the source widget and the attribute information) corresponding to the file name acquired. Next, the widget development unit 514 stores the parameters and the widget name included in the request in the attribute information of the actual widget 21. As a result, the copy becomes the real derivation widget (step S409).

Then, the widget development unit 514 stores a record corresponding to the made derivation widget in individual widget list store unit 523 (step S410). Specifically, a copy of a record corresponding to the derivation widget is made based on the record corresponding to the source widget associated with the login user in the individual widget list store unit 523, but without the record ID. Therefore, the record ID of the derivation widget is generated with a value different from the record ID of the source widget.

The parent widget ID corresponding to the derivation widget is registered with the record ID corresponding to the source widget, and the child widget ID are registered with null values. The child widget ID corresponding to the source widget is registered with the record ID corresponding to the derivation widget. However, the derivation widget is not stored in the widget list store unit 522. In other words, the user making the derivation widget is only available to the user that makes the derivation widget.

Next, the widget development unit 514 sends the made derivation widget to the Web browser 23 (step S411). The web browser stores the received derivation widget to a memory device in the user terminal 20 (step S412). As a result, the derivation widget is available in the user terminal 20.

The derivation widget is made to decrease the burden to operate a widget 21. If the widget 21 is running, an icon corresponding to the widget 21 is displayed during its execution. The user can display an edit parameter screen page to edit parameters with the icon. The parameters edited in the edit parameter screen page are sent to the widget manager 22 to be registered as the widget information corresponding to the widget 21 in the widget information management table 226. In other words, users can activate a widget 21 and specify different parameters without making the derivation widget.

If a user often activates a widget 21 specifying certain parameters, it is too much trouble to display the edit parameter screen page to edit parameters with each activation. Therefore, the user can activate widget 21 having the certain parameters without displaying the edit parameter screen page by making the derivation widget in advance.

In the scan OCR distribution widget 21c case, a derivation widget may have editted parameters including the scan setting information, the identifier to execute for OCR web service, and the identifier to send an OCR result.

A description is given of a process of reusing the history information (execution history) of widgets 21. According to steps S211-S225 shown in FIG. 8 as described above, the widget management server 50 integrally stores the execution history of widgets 21. For example, users can access or reuse the execution history. To reuse the execution history means using terminal data or intermediate data previously generated by a widget that was previously activated.

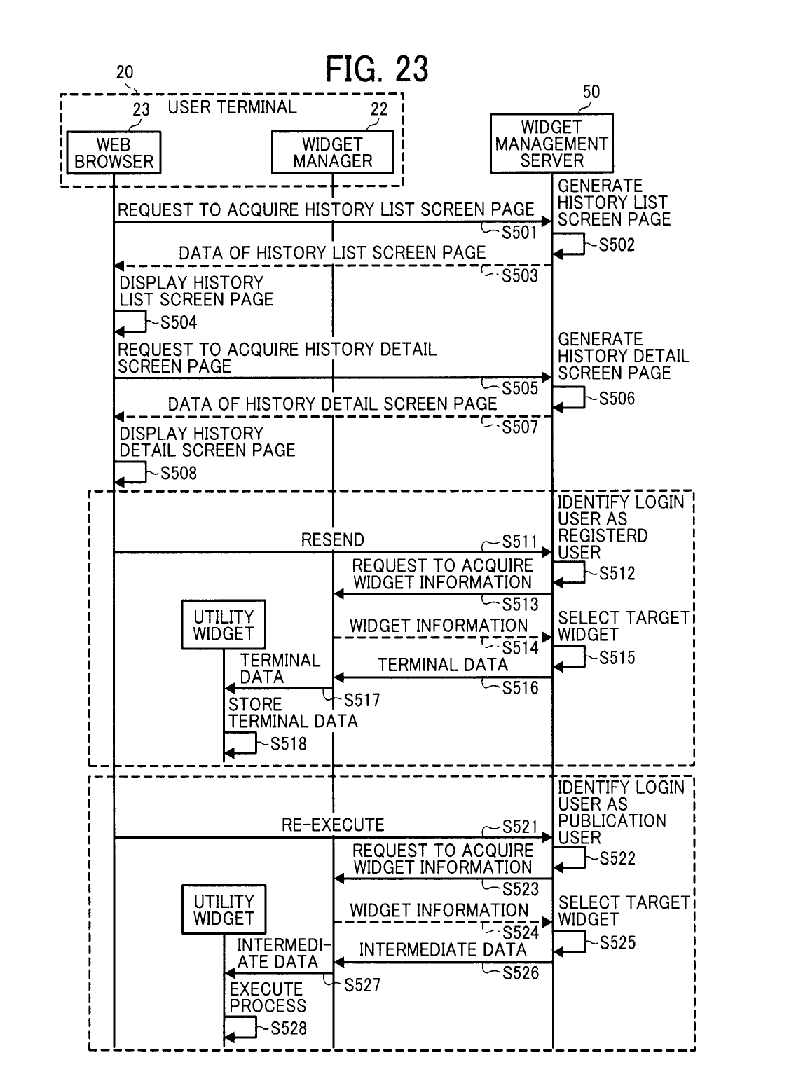

FIG. 23 is a sequence diagram for describing processing procedures performed when reusing an execution history. This description is made based on the premise that the widget list screen page 810 is displayed in the Web browser 23 in the user terminal in response to a request (step S501).

If one of the icons is selected in the area 811 in the individual widget list screen page 810, the Web browser 23 sends a request to acquire an execution history list screen page based on a hyperlink corresponding to the widget (hereinafter, “target widget”) corresponding to the selected icon to the widget management server 50. The request specifies the record ID.

In response to a request to acquire an execution history list screen page, the history providing unit 517 in the widget management server 50 generates data of the history list screen page from the individual widget list store unit 523 (shown in FIG. 17) or the individual history store unit 524 (shown in FIG. 12) corresponding to the login user (step S502). Next, the history providing unit 517 sends the data of the history list screen page to the Web browser 23 (step S503). The Web browser 23 displays the history list screen page based on the received data of the history list screen page (step S504).

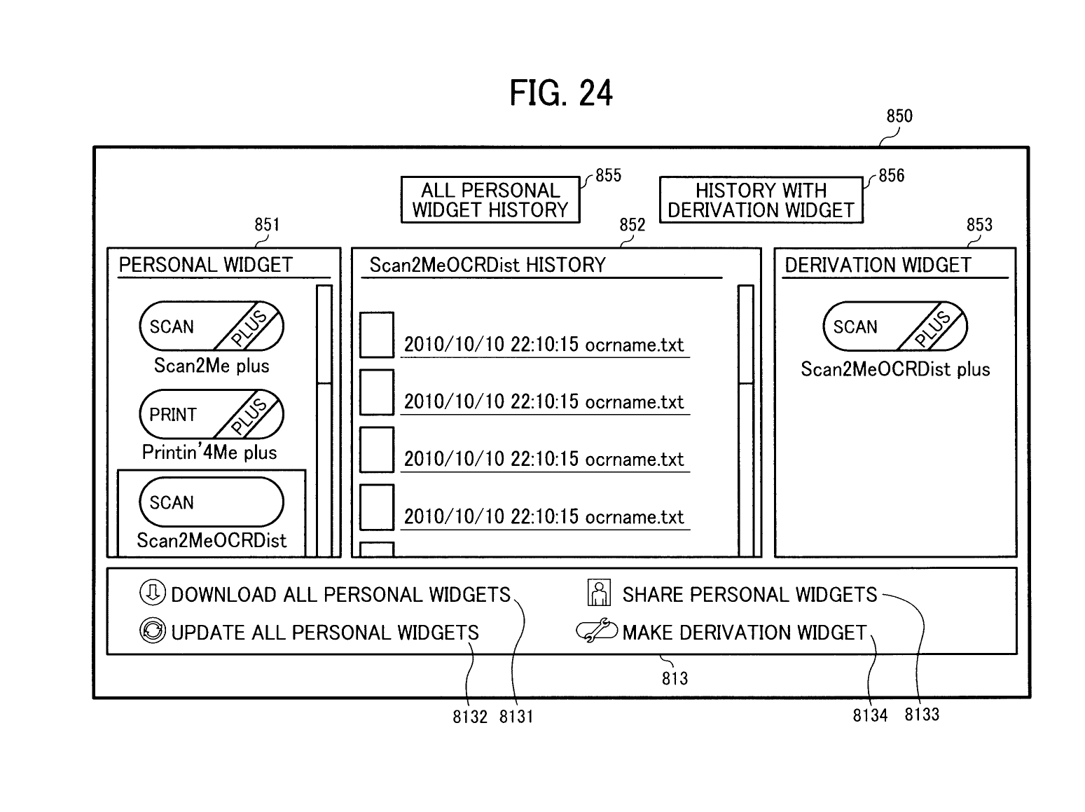

FIG. 24 illustrates an example of a displayed history list screen page 850. Elements shared with FIG. 24 and FIG. 18 have common symbols, and descriptions of the elements are not repeated.

An area 851 of the history list screen page 850 displays a list of personal widgets. The target widget has been selected in the area 851. An area 852 displays a list of the execution history of the widgets corresponding to the target widget from the individual history store unit 524. Each date of execution and a file name of terminal data are displayed in the execution history shown in FIG. 24. An area 853 displays a list of the derivation widgets corresponding to the target widget from the individual widget list store unit 523. If there are no derivation widgets corresponding to the target widget, the area 853 does not display any widgets.

If a derivation widget is selected in the area 853, the area 851 displays a list of the derivation widget displayed in the area 853. Then, the derivation widget is selected in the area 851. The area 853 displays a list of derivation widgets corresponding to the selected derivation widget. Therefore, the relationship between widgets is arranged in a hierarchy. On the other hand, the area 853 may display not only the derivation widgets corresponding to the selected derivation widget but also the personal widgets corresponding to the selected derivation widget.

A button 855 is a button to display the execution history of all personal widgets. In other words, if the button 855 is clicked, the area 852 displays a list of history corresponding to not only the target widget but also all personal widgets (all history in the individual history store unit 524 corresponding to the login user).

A button 856 is a button to display the execution history of the target widget and the derivation widgets corresponding to the target widget. In other words, if the button 856 is clicked, the area 852 displays a list of history corresponding to not only the target widget but also all derivation widgets corresponding to the target widget.

Each of the execution histories is associated with a hyperlink. In response to a click to select one of the execution histories, the Web browser 23 sends a request to acquire a history detail screen page corresponding to the selected history to the widget management server 50 (step S505). The request to acquire a history detail screen page specifies a history ID of the selected history (hereinafter, “target history”). In response to the request to acquire a history detail screen page, the history providing unit 517 acquires an execution history corresponding to the specified history ID from the individual history store unit 524, and generates data to display the history detail screen page based on the acquired execution history (step S506). Next, the history providing unit 517 sends the data to display the history detail screen page to the Web browser 23 (step S507). The Web browser 23 displays the history detail screen page based on the received data of the history detail screen page (step S508).

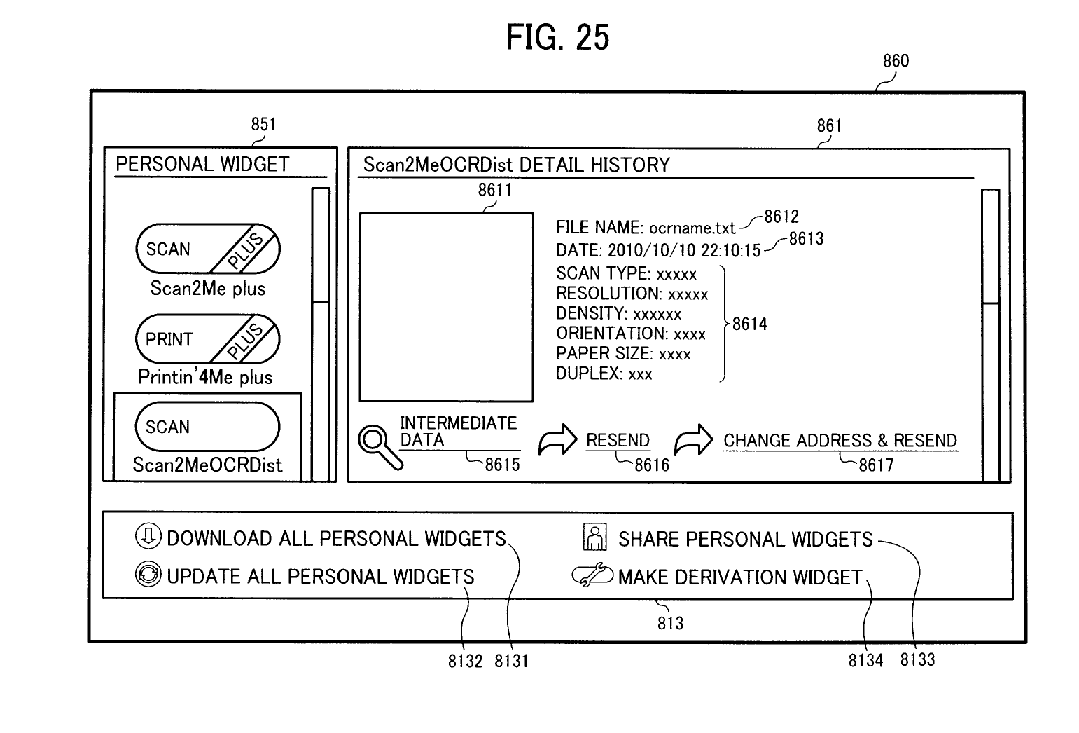

FIG. 25 illustrates an example of a displayed history detail screen page 860. Elements shared with FIG. 25 and FIG. 24 have common symbols, and descriptions of those elements are not repeated.

An area 861 in the history detail screen page 860 displays detailed information of the target history including a thumbnail-size image of the terminal data 8611, a file name of the terminal data 8612, a date of execution 8613, and the parameters 8614.

An area 861 includes some hyperlinks (8615, 8616 and 8617). The hyperlink 8616 is a link to resend a displayed terminal data. To resend the terminal data means downloading terminal data to the user terminal 20 currently used by the user.

Specifically, in response to a click to select a hyperlink 8616 (RESEND), the Web browser 23 sends a request to resend the terminal data to the widget management server 50 (step S511). The request to resend the terminal data specifies the history ID. In response to the request to resend the terminal data, the reuse control unit 518 in the widget management server 50 identifies the login user as a user registered in the server active user list (Shown in FIG. 7) (step S512). In other words, identifying the login user as a advertisement user at step S113 shown in FIG. 5

If the user ID of the login user is registered in the server active user list, the reuse control unit 518 acquires a widget information acquiring URL corresponding to the user ID from the server active user list, and sends a request to acquire widget information using the widget information acquiring URL.

The widget information providing unit 223 in the widget manager 22 receives the request to acquire widget information (step S513). The widget information providing unit 223 acquires a list of widget information registered in the widget information management table 226 corresponding to the widget information acquiring URL, and sends the list of widget information to the widget management server 50 (step S514). When sending the list of widget information, the widget information providing unit 223 generates a unique widget relay URL corresponding to each widget 21 to relay communications between the widget management server 50 and each widget 21. The widget information providing unit 223 sends the widget information attached with the widget relay URL corresponding to each widget 21 (shown in FIG. 10) to the widget management server 50.

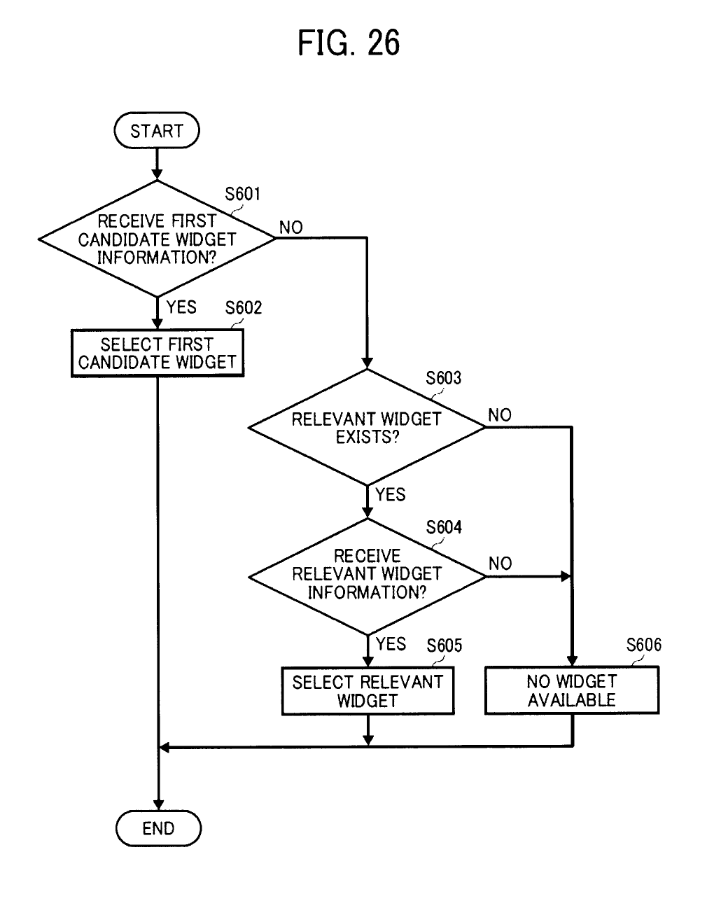

FIG. 26 is a flowchart for describing processing procedures performed when resending terminal data at step S515 shown in FIG. 23.

The reuse control unit 518 determines whether first candidate widget information is received at step S514. The candidate widget information means a widget 21 registered in the reuse control unit 518 in advance to send terminal data. According to the present embodiment, a candidate widget is a scan widget 21a that is used to send the terminal data. Specifically, the widget ID, the widget name and the version of the scan widget 21a are registered in the reuse control unit 518. Therefore, the reuse control unit 518 determines whether the widget information of the scan widget 21a including the widget ID, the widget name and the version exists in the list of the widget information received at step S514.

The scan widget 21a becomes the first candidate widget regardless of the target widget in the history detail screen page 860 because the scan widget 21a is convenient for performing a process for downloading terminal data from the widget management server 50 to the user terminal 20 through the widget manager 22. In the case of the scan widget 21a, scan image data sent by the widget manger 22 corresponds to the terminal data (that is to say, not performing other processes for a scan image data).

However, a scan widget 21 is not always installed in the user terminal 20 of login user. Further, even if a scan widget 21 is installed in the user terminal 20 of the login user, the scan widget may not necessarily be executing on the user terminal 20.

Therefore, step S601 is performed. If the first candidate widget information is received at step S514 (Yes at step S601), the reuse control unit 518 selects a scan widget 21 corresponding to the first candidate widget (S602). In this case, the scan widget is executed. On the other hand, when the first candidate widget information is not received (No at step S601), the reuse control unit 518 determines whether a widget having a relationship or that is associated with the scan widget 21a (hereinafter, “relevant widget”) exists by referring to the widget list store unit 522 and the individual widget list store unit 523 (step S603). The relevant widget corresponding to a certain widget means a widget having common functions with the certain widget. Specifically, the relevant widget may be a source widget, a derivation widget, an upgraded widget or a recommended widget corresponding to the certain widget. The priorities for selecting a relevant widget within these widgets is appropriately determined depending on various practices. According to the present embodiment, a derivation widget corresponding to the scan widget 21a is selected in reference to the individual widget list store unit 523 first. A source widget is selected second, followed by a child widget, and a parent widget by referring to the widget list store unit 522.

If a relevant widget exists (Yes at S603), the reuse control unit 518 determines whether the widget information of the relevant widget including the widget ID, the widget name and the version exists in the list of the widget information received at step S514. In other words, the reuse control unit 518 determines whether the relevant widget is executing in the user terminal 20.

If the relevant widget information is received at step S514 (Yes at step S604), the reuse control unit 518 selects the relevant widget corresponding to the scan widget 21 (step S605).

If there are no relevant widgets (No at step S603), or the appropriate widget information was not received at step S514 (No at step S604), the reuse control unit 518 recognizes that no widget is available to resend the terminal data (step S606).

Back to FIG. 23, if there are no widgets to resend the terminal data at step S515 shown in FIG. 26, the reuse control unit 518 sends data to display an error screen page. In this case, the Web browser 23 displays the error screen page to cancel the process for resending the terminal data.

If there is a widget to resend the terminal data (hereinafter, “utility widget”) at step S515 shown in FIG. 26, the reuse control unit 518 acquires the terminal data corresponding to the target history, and sends the terminal data to the widget relay URL included in the widget information of the utility widget (step S516). Parameters including the widget information are also sent to the widget relay URL with the terminal data. However, the parameters are not edited.

The relay unit 224 of the widget manager 22 receives the terminal data and the parameters sent to the widget relay URL. The relay unit 224 stores the terminal data and the parameters associated with the widget information management table 226 corresponding to the widget relay URL to a memory device.

On the other hand, the utility widget executing in the user terminal 20 performs polls the widget manager 22 to confirm whether image data has been obtained by a scanning process at the image forming apparatus 10. In response to the request to acquire the scan image data, the relay unit 224 sends the terminal data and the parameters associated with the widget information management table 226 (step S517). The utility widget stores the received terminal data to a folder including the received parameters (step S518).

The processing procedures S513-S516 between the widget management server 50 and the widget manger 22 are similar to the processing procedures S204-S209 shown in FIG. 8 between the image forming apparatus 10 and the widget manger 22. In other words, the widget management server 50 accesses a web interface of the widget manager 22 that the widget manager 22 uses to acquire scan image data from the image forming apparatus 10. Accordingly, from the point of view of the widget manager 22, resending of terminal data from the widget management server 50 corresponds to sending of scan image data from the image forming apparatus. Therefore, the widget manger 22 sends the terminal data to the utility widget in response to polling performed by the utility widget as similar to sending scan image data in steps S117 or S211 shown in FIG. 8.

If a utility widget is a widget performing other processes for scan image data (for example, scan OCR widget 21b) the utility widget executes an OCR process on the terminal data. In this case, a purpose to resend can not be achieved.

Therefore, a utility widget is the scan widget 21a or a relevant widget corresponding to the scan widget 21a.

If the hyperlink 8617 (CHANGE ADDRESS & RESEND) is selected in the history detail screen page 860 (shown in FIG. 25), terminal data is resent (downloaded) to another address from parameters of the utility widget. Specifically, after performing steps S511-515 (that is to say, determining the utility widget), the reuse control unit 518 generates data to display the change address screen page, and sends the data to display the change address screen page to the Web browser 23.

In response to an entry to change the address in the change address screen page, the Web browser 23 sends the changed address to the reuse control unit 518. The reuse control unit 518 registers the received address to the parameters. Therefore, the parameters including the changed address are sent with the terminal data to the utility widget at steps S516-S517. As a result, the utility widget stores the terminal data to an address different from the address defined in the parameters of the utility widget. A function for the address varies depending on each widget 21. In the case of a widget storing scan image data to a user terminal 20 such as the scan widget 21a or the scan OCR widget 21b, address means a folder which the scan image data is stored in.

If the hyperlink 8615 (INTERMEDIATE DATA) is selected in the history detail screen page 860 (shown in FIG. 25), the area 8611 displays a thumbnail-size image of the intermediate data. However, if history information of the target history does not include intermediate data, the hyperlink 8615 is not displayed.

If the hyperlink 8616 or the hyperlink 8617 is selected when a thumbnail-size image of the intermediate data is displayed, the processes are performed for the intermediate data.

Specifically, in response to a click to select a hyperlink 8616 (RESEND), the Web browser 23 sends a request to resend intermediate data to the widget management server 50 (step S521). The request to resend the intermediate data specifies the history ID. In response to the request to resend the intermediate data, the reuse control unit 518 in the widget management server 50 performs a processing procedure similar to steps S512, S513 (steps S522, S523). As a result, the widget management server 50 receives the list of widget information from the widget information providing unit 223 of the widget manager (step S524).

Next, the reuse control unit 518 performs a processing procedure similar to the one shown in FIG. 26 to determine whether there is a utility widget to resend the intermediate data (step S525). However, the first candidate becomes a target widget (selected in the area 851 in the history detail screen page 860) when sending the intermediate data. Therefore, a utility widget is the target widget or a relevant widget corresponding to the target widget. In other words, resending intermediate data means causing a widget for performing a process for the intermediate data to perform the process for the intermediate data again.

At steps S526-S527, a processing procedure similar to steps S516-S517 is performed for intermediate data instead of terminal data. At step S528, the utility widget performs a processing procedure for intermediate data that is similar to the procedure performed for scan image data. For example, if the utility widget is the scan OCR distribution widget 21c, the utility widget performs a similar processing procedure as steps S212-S214 shown in FIG. 8 for the intermediate data.

A description of the process performed upon selection of the hyperlink 8617 when the thumbnail-size image 8611 displayed is of the intermediate data is omitted, because the process is self-explanatory based on the preceding description on the displayed history detail screen page 860. Further, the address means a destination to distribute the intermediate data in the case of the scan OCR distribution widget 21c.

Resending terminal data may be useful when a user executes the process shown in FIG. 23 on a user terminal that is different from the original user terminal on which the process that created the terminal data was executed. For example, if a user executes the process shown FIG. 23 in a user terminal B after the user had previously executed the process shown in FIG. 8 in a user terminal A, the user can download terminal data to the user terminal B without executing the scan OCR distribution widget 21c.

Resending intermediate data may also be useful when a processing procedure for the intermediate data has changed. For example, if the OCR server 60 is changed to another OCR server, the user can easily get an OCR result data by the other OCR server executing an OCR process.

Next, a description is given of an operation of the widget list screen page 810, the history list screen page 850 and the history detail screen page 860.

In response to a click to select a hyperlink 8131 in the area 813 (“DOWNLOAD ALL PERSONAL WIDGETS”), the Web browser 23 sends a request to download all personal widgets to the widget management server 50. The download control unit 513 in the widget management server 50 acquires all widgets registered in the individual widget list store unit 523, corresponding to the login user from the widget store unit 521, and sends the widgets to the Web browser 23. The Web browser 23 stores the received widgets to the user terminal 20.

As a result, the user can install the same widgets to each of a pluralality of user terminals 20.

In response to a click to select a hyperlink 8132 in the area 813 (“UPDATE ALL PERSONAL WIDGETS”), the Web browser 23 sends a request to update all personal widgets to the widget management server 50. The download control unit 513 in the widget management server 50 determines whether each of the widgets registered in the individual widget list store unit 523, corresponding to the login user, is upgraded in reference to the widget list store unit 522.

Specifically, the download control unit 513 determines whether there are child widgets (widgets having the same widget ID, same widget name and of a newer version) corresponding to each of the widgets registered in the individual widget list store unit 523. If there are child widgets, the download control unit 513 acquires child widgets from the widget store unit 521, and sends the child widgets to the Web browser 23. Further, the download control unit 513 registers widget information of the child widgets to the individual widget list store unit 523. The Web browser 23 stores the received widgets to the user terminal 20.

As a result, the user can upgrade all the widgets installed in the user terminal 20.

In response to a click to select a hyperlink 8133 in the area 813 (“SHARE PERSONAL WIDGETS”), the Web browser 23 displays a list of users that have installed some widgets. The individual widget list store unit 523 corresponding to each user is stored in the widget management server 50. If one of the users is selected, the Web browser 23 sends a request to acquire the personal widgets corresponding to the selected user to the management server 50 specifying the selected user ID.

The download control unit 513 in the widget management server 50 acquires all the widgets registered in the individual widget list store unit 523 corresponding to the specified user from the widget store unit 521, and sends the widgets to the Web browser 23. The Web browser 23 stores the received widgets to the user terminal 20.

As a result, the user can install the same widgets as those stored on another user's user terminal 20.

The present invention is not limited to the specific embodiments described herein, and variations and modifications may be made without departing from the scope of the present invention.

What is claimed is:

1. An information management system, comprising:
a relay unit configured to receive a request, including an identifier and a parameter, to execute a scanning process on an image forming apparatus that is selected by a user, to send the request to the image forming apparatus, to receive image data from the image forming apparatus, and to return the image data to an application in an apparatus and corresponding to the identifier; and
an information management apparatus, including
a history recording unit configured to receive and record history information including the identifier, the parameter, and the image data, and
a history providing unit configured to send a list of the history information recorded in the history recording unit in response to receiving a request to display the history information.

2. The information management system according to claim 1, further comprising:
a relevant store unit configured to store relationship information based on whether the application has common functions with other applications, wherein
the history providing unit is configured to send the list of history information of the application corresponding to the identifier and the list of history information of other applications related to the application.

3. The information management system according to claim 1, further comprising:
a reuse control unit configured to send image data corresponding to one of the list of history information to the relay unit and to specify an address of a utility application that is configured to send a request to execute the scanning process, wherein
the relay unit is configured to send the image data in response to the request to execute the scanning process from the utility application corresponding to the specified address.

4. The information management system according to claim 3, wherein
the reuse control unit is configured to receive a list of at least one application executing in the apparatus, and to send the image data to the relay unit and to specify an address of another application related to the application when the list of at least one application does not include the utility application.

5. The information management system according to claim 3, wherein
the history recording unit is configured to receive terminal data which is generated by the application when the processing to be performed by the application is completed, and
the relay unit is configured to send the terminal data in response to the request to execute the scanning process from the utility application corresponding to the specified address.

6. The information management system according to claim 5, wherein
the reuse control unit is configured to receive a list of at least one application executing in the apparatus, to send the terminal data to the relay unit and to specify an address of another apparatus that is related to the application when the list of at least one application does not include the application.

7. An information management apparatus configured to connect to an image forming apparatus and a relay unit via a network, the information management apparatus comprising:
a history recording unit configured to receive and record history information including an identifier, a parameter, and image data sent by the relay unit; and
a history providing unit configured to send a list of the history information recorded in the history recording unit in response to receiving a request to display the history information.

8. A method of an information management system including a relay unit and an information management apparatus, the method comprising:
receiving, by the relay unit, a request, including an identifier and a parameter, to execute a scanning process on an image forming apparatus selected by a user;
sending, by the relay unit, the request to the image forming apparatus;
receiving, by the relay unit, image data from the image forming apparatus;
returning, by the relay unit, the image data to an application corresponding to the identifier;
receiving, by the information management apparatus, history information including the identifier, the parameter, and the image data;
recording, by the information management apparatus, the history information; and
sending a list of the history information in the information management apparatus in response to receiving a request to display the history information.

9. The information management system according to claim 3, wherein
the history recording unit is configured to receive and record intermediate data and terminal data which are generated during execution of the widget, the terminal data being generated from the intermediate data, and
the relay unit is configured to send the intermediate data in response to the request to execute the scanning process from the application corresponding to the specified address.

10. The information management system according to claim 1, wherein
the history providing unit is configured to send the list of the history information recorded in the history recording unit in response to receiving the request to display the history information from a web browser.

11. The information management apparatus according to claim 7, wherein
the history providing unit is configured to send the list of the history information recorded in the history recording unit in response to receiving the request to display the history information from a web browser.

12. The method according to claim 8, wherein the step of sending the list comprises:
sending the list of the history information in the information management apparatus in response to receiving the request to display the history information from a web browser.
